(19) United States
(12) Patent Application Publication
(10) Pub. No.: US 2025/0242262 A1
(43) Pub. Date: Jul. 31, 2025

(54) STORAGE MEDIUM, GAME SYSTEM, GAME APPARATUS, AND GAME PROCESSING METHOD

(71) Applicant: Nintendo Co., Ltd., Kyoto (JP)

(72) Inventor: Wataru TANAKA, Kyoto (JP)

(21) Appl. No.: 19/005,077

(22) Filed: Dec. 30, 2024

(30) Foreign Application Priority Data
Jan. 30, 2024 (JP) 2024-011592

(51) Int. Cl. A63F 13/69; A63F 13/52

(52) U.S. Cl. CPC A63F 13/69; A63F 13/52

(57) ABSTRACT

Terrain volume data representing a shape of a terrain in a virtual space, and object data representing an object placed at a location where at least a portion of the object is buried in the terrain, are stored in a storage medium. When a destruction event in which the terrain is broken based on a user's operation input occurs, the voxel data is updated such that the voxel data indicates the absence of the terrain with respect to a voxel included in a removal range set based on a location of the occurrence of the destruction event, and a first game process is executed, based on whether or not the object is buried in the terrain based on the terrain volume data after the destruction event.

### CROSS REFERENCE TO RELATED APPLICATIONS

This application claims priority to Japanese Patent Application No. 2024-011592, filed on Jan. 30, 2024, the entire contents of which are incorporated herein by reference.

### FIELD

The technology disclosed herein relates to storage media, game systems, game apparatuses, and game processing methods that are capable of executing a process of generating an image using voxel data.

### BACKGROUND AND SUMMARY

There is a conventional image generation system that displays a game image by creating character voxels based on imaging information and generating polygon mesh information.

However, in such an image generation system, voxels are used in a game in order to use imaging information, and an object or the like generated from the voxels is not supposed to be deformed.

With the above in mind, the present example discloses a storage medium, game system, game apparatus, and game processing method that are capable of deforming an object generated from voxels with a high degree of freedom according to a user's operation in a game.

The present example may have the following features, for example.

An example configuration of a non-transitory computer-readable storage medium having stored therein a game program according to the present example is executed by one or more processors of an information processing apparatus. The game program causes the one or more processors to execute information processing comprising: storing, in a storage medium, terrain volume data holding voxel data indicating the presence of a terrain for each voxel included in a voxel space set in a virtual space and thereby representing a shape of the terrain in the virtual space, and object data representing an object placed at a location where at least a portion of the object is buried in the terrain; when a destruction event in which the terrain is broken based on a user's operation input occurs, updating the voxel data such that the voxel data indicates the absence of the terrain with respect to a voxel included in a removal range set based on a location of the occurrence of the destruction event, and executing a first game process, based on whether or not the object is buried in the terrain based on the terrain volume data after the destruction event; and generating an image of the virtual space by rendering at least a polygon mesh representing a surface of the terrain, based on the terrain volume data.

Thus, a game can be played in which a terrain generated from voxels is deformed with a high degree of freedom according to the user's operation, and an object buried in the terrain is used.

The information processing may further comprise: executing the first game process, additionally based on whether or not the object is supported by the terrain based on the terrain volume data after the destruction event.

Thus, a game can be embodied in which a state in which an object is supported by a terrain is destroyed by causing a destruction event and thereby deforming the terrain.

The information processing may further comprise: identifying a contact site between a first determination shape that is a shape of the object or a basic shape including the object, and the terrain; and executing first determination to determine that the object is buried in the terrain when a ratio of a volume or surface area of a second determination shape that is a basic shape including the contact site to that of the first determination shape is higher than a reference.

Thus, the load of the determination process can be reduced by using the volume ratio or surface area of the basic shape.

The information processing may further comprise: executing second determination to determine whether or not the object is supported by the terrain, based on a positional relationship of the centroid of the first determination shape and the second determination shape; and executing the first game process, based on the first determination and the second determination.

Thus, the object support determination can be easily performed using the positional relationship of the basic shape.

In the second determination, it may be determined that the object is supported by the terrain, when the second determination shape or a third determination shape including the second determination shape includes the centroid in terms of components other than a height direction, and at least a portion of the second or third determination shape is located lower than the centroid in terms of the height direction.

Thus, the object support determination can be easily performed, based on whether or not the centroid of the first determination shape is located above the second determination shape or the third determination shape.

The information processing may further comprise: executing the first game process when it is determined in the first determination that the object is not buried in the terrain, and it is determined in the second determination that the object is not supported by the terrain, or when an event occurs.

Thus, a game process can be executed using a situation in which an object is not buried in a terrain and is not supported by the terrain.

The first determination shape may be a bounding box for the object, and the second determination shape may be a bounding box for the contact site

Thus, the determination shape used in the determination process can be easily set.

The bounding box may be a directed bounding box.

Thus, the determination process can be more correctly performed.

The information processing may further comprise: causing a player character to perform an action of breaking the terrain, based on the user's operation input. In the destruction event, the terrain may be hit by the player character's breaking action.

Thus, the process of deforming a terrain, based on the player character's breaking action, and the process based on whether or not an object is buried in the terrain after the breaking action, are executed, and therefore, unnatural feeling caused by a change in the extent to which the object is buried can be reduced.

The first game process may be to obtain an item associated with the object.

Thus, a game can be embodied in which an item is obtained by unearthing an object buried in a terrain.

The first game process may be to cause the object to drop in the virtual space.

Thus, a game can be embodied in which an object buried in a terrain is unearthed by breaking the terrain.

In the absence of the destruction event, the object may be placed at a location where a hole having a basic shape smaller than that of the object is formed in a surface or inside of the terrain.

Thus, the shape of a terrain in which an object is to be buried can be easily formed, and a process using the shape of a terrain in which an object is buried can be easily executed.

The information processing may further comprise: generating the polygon mesh according to an algorithm that determines a location of a vertex of a polygon between a voxel in which the terrain is absent and a voxel in which the terrain is present, based on the voxel data; and recalculating vertices of the polygon mesh in a range including at least a voxel whose voxel data has been updated, based on the occurrence of the destruction event.

Thus, the recalculation of the vertices of a polygon mesh is limited to a range including voxels whose voxel data has been updated, resulting in a reduction in processing load.

The present example may be carried out in the form of a game system, game apparatus, and game processing method.

With the present example, a game can be played in which a terrain generated from voxels is deformed with a high degree of freedom according to the user's operation, and an object buried in the terrain is used.

These and other features, aspects and advantages of the subject matter described herein will become more apparent from the following detailed description of the present embodiment when taken in conjunction with the accompanying drawings.

### BRIEF DESCRIPTION OF THE DRAWINGS

FIG. 1 is a diagram illustrating a non-limiting example of a state where a left controller 3 and a right controller 4 are attached to a main body apparatus 2,

FIG. 2 is a diagram illustrating a non-limiting example of a state where a left controller 3 and a right controller 4 are detached from a main body apparatus 2,

FIG. 3 illustrates six orthogonal views of a non-limiting example of a main body apparatus 2,

FIG. 4 illustrates six orthogonal views of a non-limiting example of a left controller 3.

FIG. 5 illustrates six orthogonal views of a non-limiting example of a right controller 4,

FIG. 6 is a block diagram illustrating a non-limiting example of an internal configuration of a main body apparatus 2,

FIG. 7 is a block diagram illustrating non-limiting examples of internal configurations of a main body apparatus 2, a left controller 3, and a right controller 4,

FIG. 8 is a view showing a non-limiting example of a terrain object, which is a voxel object,

FIG. 9 is a view showing a non-limiting example before removal of a portion of the terrain object shown in FIG. 8,

FIG. 10 is a view showing a non-limiting example after removal of a portion of the terrain object shown in FIG. 8,

FIG. 11 is a diagram showing a non-limiting example of content of voxel data,

FIG. 12 is a diagram showing a non-limiting example of property information representing properties of materials,

FIG. 13 is a diagram showing a non-limiting example of texture information representing textures of materials,

FIG. 14 is a diagram showing a non-limiting example of a method for generating a mesh,

FIG. 15 is a diagram showing a non-limiting example of a game image including a terrain object,

FIG. 16 is a diagram showing a non-limiting example of a game image on a display 12 showing a buried object OBJ that is partially buried in a terrain object TO,

FIG. 17 is a diagram for describing a non-limiting example of a small box SB and a main box MB that are set for a buried object OBJ,

FIG. 18 is a vertical cross-sectional view showing a non-limiting example of a state of a buried object OBJ buried in and fixed to a terrain object TO,

FIG. 19 is a diagram showing a non-limiting example of a game image showing that a player character PC performs an action of breaking a portion of a terrain object TO,

FIG. 20 is a diagram showing a non-limiting example showing how a buried object OBJ drops from a location where the buried object has been buried in a terrain object TO,

FIG. 21 is a diagram showing a non-limiting example of a destruction range of voxels to be broken in a terrain object TO,

FIG. 22 is a diagram showing a non-limiting example of various kinds of data used in an information process executed in a game system 1,

FIG. 23 is a flowchart showing a non-limiting example of a flow of a game process that is executed in a game system 1, and

FIG. 24 is a subroutine showing a non-limiting example of a burial determination process of step S10 in the flowchart of FIG. 23.

### DETAILED DESCRIPTION OF NON-LIMITING EXAMPLE EMBODIMENTS

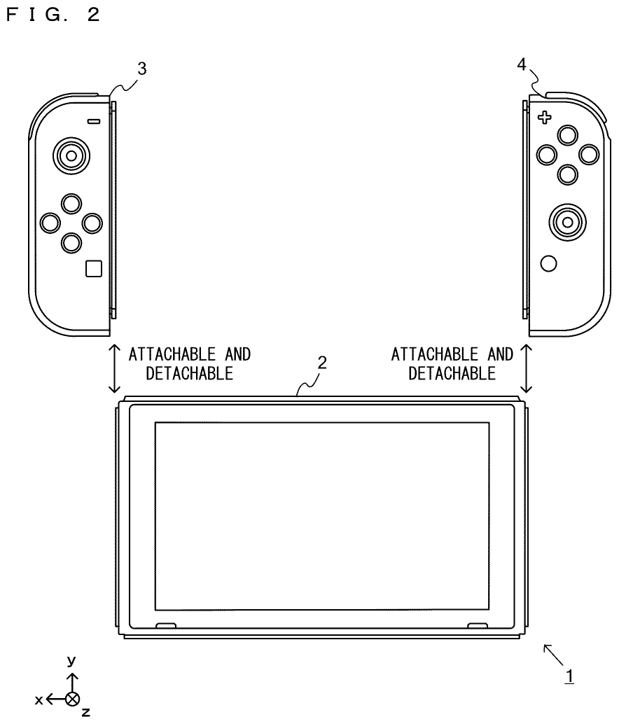

A game system according to the present embodiment will now be described. A non-limiting example of a game system 1 according to the present embodiment includes a main body apparatus (information processing apparatus serving as the main body of a game apparatus in the present embodiment) 2, a left controller 3, and a right controller 4. The left controller 3 and the right controller 4 are attachable to and detachable from the main body apparatus 2. That is, the user can attach the left controller 3 and the right controller 4 to the main body apparatus 2, and use them as a unified apparatus. The user can also use the main body apparatus 2 and the left controller 3 and the right controller 4 separately from each other (see FIG. 2). In the description that follows, a hardware configuration of the game system 1 of the present embodiment is described, and thereafter, the control of the game system 1 of the present embodiment is described.

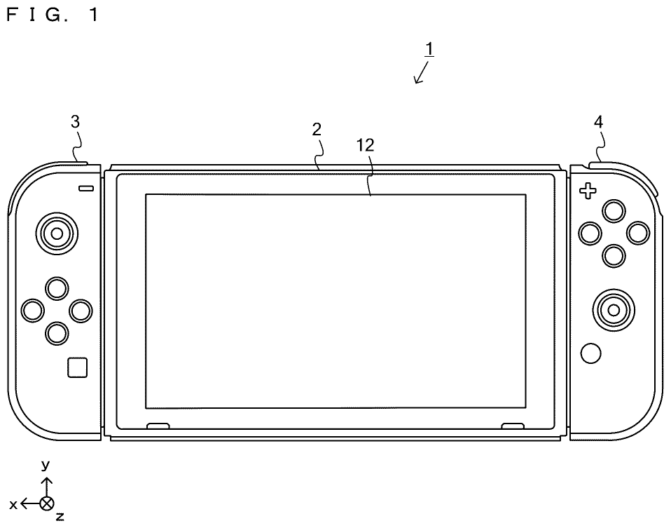

FIG. 1 is a diagram illustrating a non-limiting example of the state where the left controller 3 and the right controller 4 are attached to the main body apparatus 2. As illustrated in FIG. 1, each of the left controller 3 and the right controller 4 is attached to and unified with the main body apparatus 2. The main body apparatus 2 is an apparatus for performing various processes (e.g., game processing) in the game system 1. The main body apparatus 2 includes a display 12. Each of the left controller 3 and the right controller 4 is an apparatus including operation sections with which a user provides inputs.

FIG. 2 is a diagram illustrating a non-limiting example of the state where each of the left controller 3 and the right controller 4 is detached from the main body apparatus 2. As illustrated in FIGS. 1 and 2, the left controller 3 and the right controller 4 are attachable to and detachable from the main body apparatus 2. It should be noted that hereinafter, the left controller 3 and the right controller 4 will occasionally be referred to collectively as a “controller”.

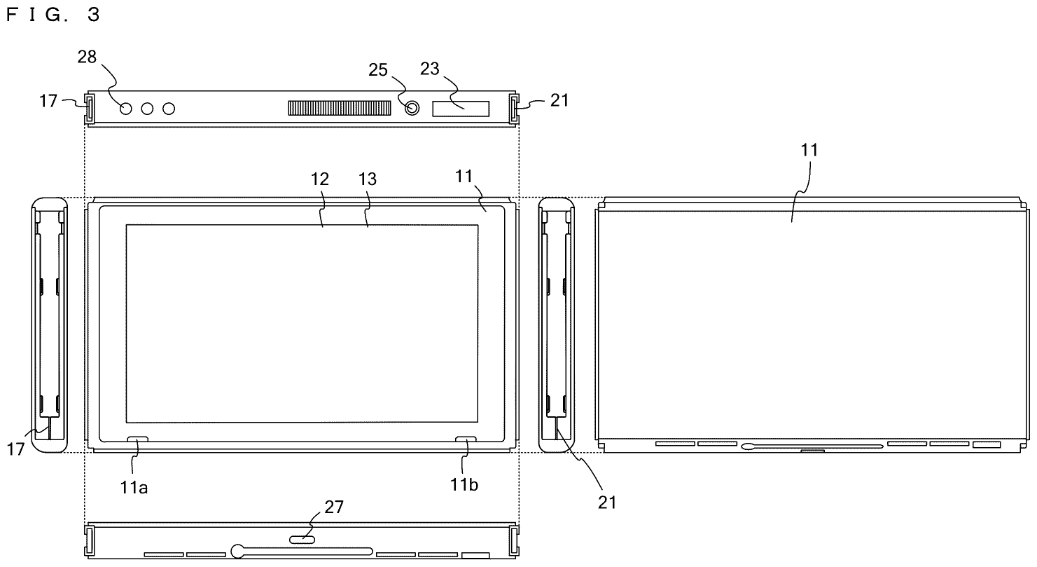

FIG. 3 illustrates six orthogonal views of a non-limiting example of the main body apparatus 2. As illustrated in FIG. 3, the main body apparatus 2 includes an approximately plate-shaped housing 11. In the present embodiment, a main surface (e.g., a surface on a front side, such as a surface on which the display 12 is provided) of the housing 11 has a generally rectangular shape.

It should be noted that the shape and the size of the housing 11 are optional. As a non-limiting example, the housing 11 may be of a portable size. Further, the main body apparatus 2 alone or the unified apparatus obtained by attaching the left controller 3 and the right controller 4 to the main body apparatus 2 may function as a mobile apparatus. The main body apparatus 2 or the unified apparatus may function as a handheld apparatus or a portable apparatus.

As illustrated in FIG. 3, the main body apparatus 2 includes the display 12, which is provided on the main surface of the housing 11. The display 12 displays an image generated by the main body apparatus 2. In the present embodiment, the display 12 is a liquid crystal display device (LCD). The display 12, however, may be a display device of any suitable type.

In addition, the main body apparatus 2 includes a touch panel 13 on the screen of the display 12. In the present embodiment, the touch panel 13 allows multi-touch input (e.g., a capacitive touch panel). It should be noted that the touch panel 13 may be of any suitable type, e.g., it allows single-touch input (e.g., a resistive touch panel).

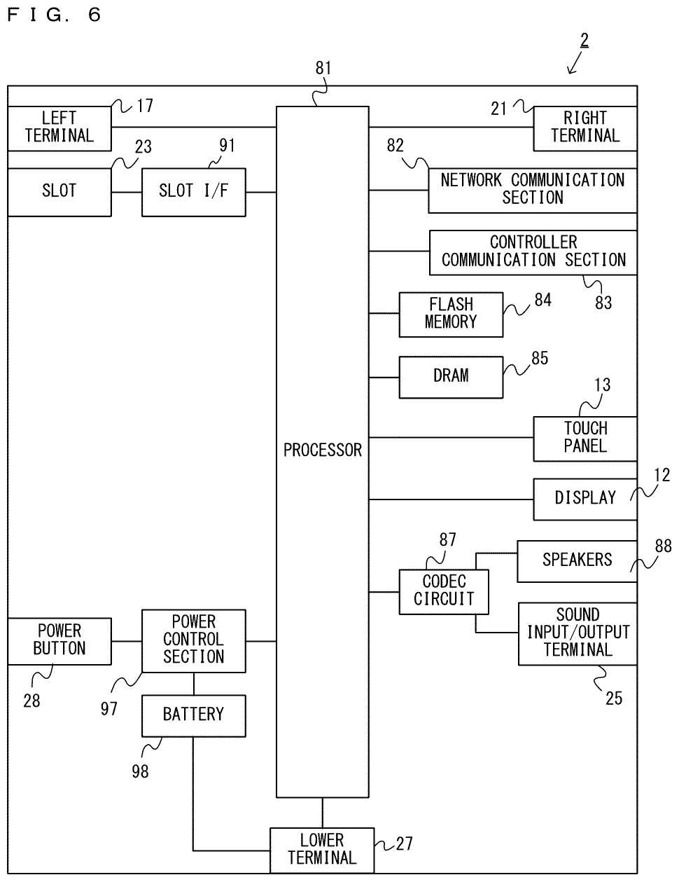

The main body apparatus 2 includes a speaker (e.g., a speaker 88 illustrated in FIG. 6) inside the housing 11. As illustrated in FIG. 3, speaker holes 11a and 11b are formed in the main surface of the housing 11. The speaker 88 outputs sounds through the speaker holes 11a and 11b.

The main body apparatus 2 also includes a left-side terminal 17 that enables wired communication between the main body apparatus 2 and the left controller 3, and a right-side terminal 21 that enables wired communication between the main body apparatus 2 and the right controller 4.

As illustrated in FIG. 3, the main body apparatus 2 includes a slot 23. The slot 23 is provided on an upper side surface of the housing 11. The slot 23 is so shaped as to allow a predetermined type of storage medium to be attached to the slot 23. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of an application or the like) used by the main body apparatus 2 and/or a program (e.g., a program for an application or the like) executed by the main body apparatus 2. Further, the main body apparatus 2 includes a power button 28.

The main body apparatus 2 includes a lower-side terminal 27. The lower-side terminal 27 allows the main body apparatus 2 to communicate with a cradle. In the present embodiment, the lower-side terminal 27 is a USB connector (more specifically, a female connector). When the unified apparatus or the main body apparatus 2 alone is placed on the cradle, the game system 1 can display, on a monitor, an image that is generated and output by the main body apparatus 2. The monitor may be stationary or may be movable. Also, in the present embodiment, the cradle has the function of charging the unified apparatus or the main body apparatus 2 alone, being placed thereon. The cradle also functions as a hub device (specifically, a USB hub).

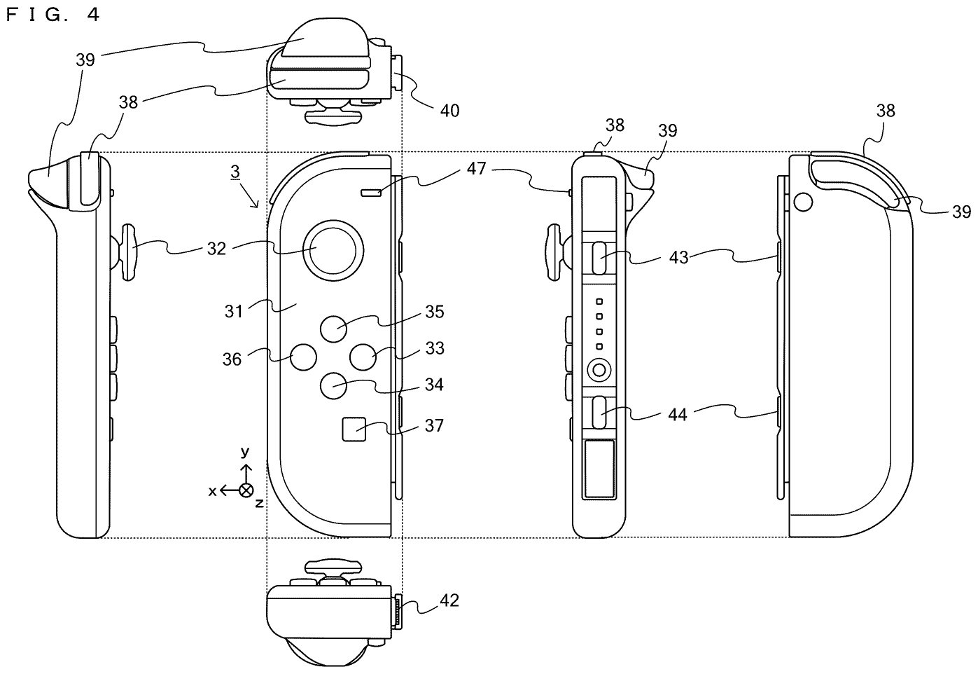

FIG. 4 illustrates six orthogonal views of a non-limiting example of the left controller 3. As illustrated in FIG. 4, the left controller 3 includes a housing 31. In the present embodiment, the housing 31 has a vertically long shape. The housing 31 may be shaped to be long in an up-down direction, e.g., along the y-axis direction illustrated in FIGS. 1 and 4. In the state where the left controller 3 is detached from the main body apparatus 2, the left controller 3 can also be held in the orientation in which the left controller 3 is vertically long. The housing 31 has such a shape and a size that when held in the orientation in which the housing 31 is vertically long, the housing 31 can be held with one hand, particularly the left hand. Further, the left controller 3 can also be held in the orientation in which the left controller 3 is horizontally long. When held in the orientation in which the left controller 3 is horizontally long, the left controller 3 may be held with both hands.

The left controller 3 includes an analog stick 32. As illustrated in FIG. 4, the analog stick 32 is provided on a main surface of the housing 31. The analog stick 32 can be used as a direction input section with which a direction can be input. The user tilts the analog stick 32 and thereby can input a direction corresponding to the direction of the tilt (and input a magnitude corresponding to the angle of the tilt). It should be noted that the left controller 3 may include a directional pad, a slide stick that allows a slide input, or the like as the direction input section, instead of the analog stick. Further, in the present embodiment, it is possible to provide an input by pressing the analog stick 32.

The left controller 3 includes various operation buttons. The left controller 3 includes four operation buttons 33 to 36 (specifically, a right direction button 33, a down direction button 34, an up direction button 35, and a left direction button 36) on the main surface of the housing 31. Further, the left controller 3 includes a record button 37 and a “−” (minus) button 47. The left controller 3 includes a first L-button 38 and a ZL-button 39 in an upper left portion of a side surface of the housing 31. Further, the left controller 3 includes a second L-button 43 and a second R-button 44, on the side surface of the housing 31 on which the left controller 3 is attached to the main body apparatus 2. These operation buttons are used to give instructions depending on various programs (e.g., an operating system (OS) program and an application program) executed by the main body apparatus 2.

The left controller 3 also includes a terminal 42 that enables wired communication between the left controller 3 and the main body apparatus 2.

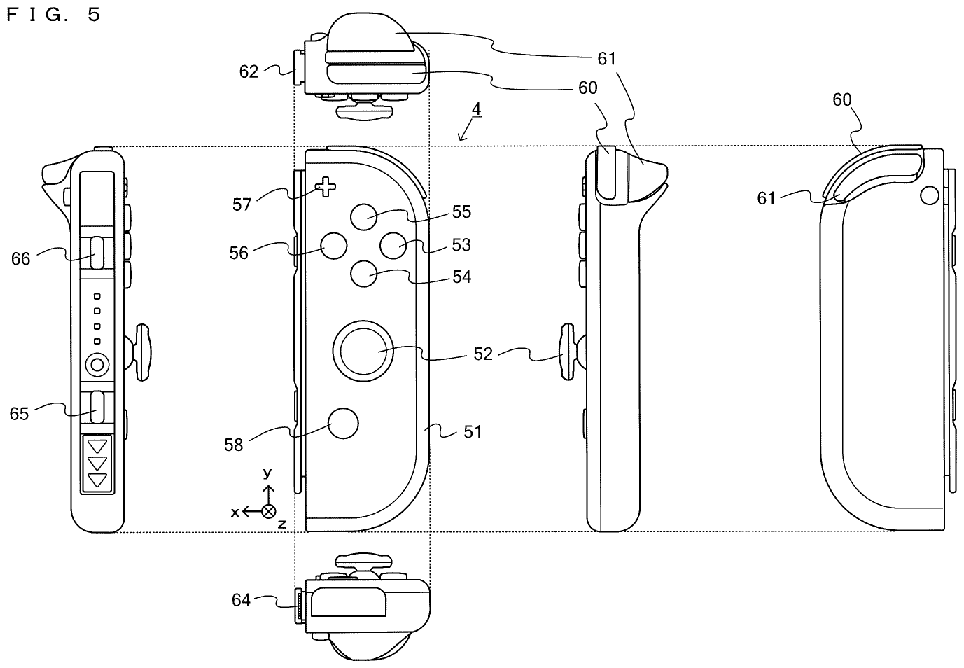

FIG. 5 illustrates six orthogonal views of a non-limiting example of the right controller 4. As illustrated in FIG. 5, the right controller 4 includes a housing 51. In the present embodiment, the housing 51 has a vertically long shape. For example, the housing 51 may be shaped to be long in the up-down direction. In the state where the right controller 4 is detached from the main body apparatus 2, the right controller 4 can also be held in the orientation in which the right controller 4 is vertically long. The housing 51 has such a shape and a size that when held in the orientation in which the housing 51 is vertically long, the housing 51 can be held with one hand, particularly the right hand. Further, the right controller 4 can also be held in the orientation in which the right controller 4 is horizontally long. When held in the orientation in which the right controller 4 is horizontally long, the right controller 4 may be held with both hands.

Similarly to the left controller 3, the right controller 4 includes an analog stick 52 as a direction input section. In the present embodiment, the analog stick 52 has the same configuration as that of the analog stick 32 of the left controller 3. Further, the right controller 4 may include a directional pad, a slide stick that allows a slide input, or the like, instead of the analog stick. Further, similarly to the left controller 3, the right controller 4 includes four operation buttons 53 to 56 (specifically, an A-button 53, a B-button 54, an X-button 55, and a Y-button 56) on a main surface of the housing 51. Further, the right controller 4 includes a “+” (plus) button 57 and a home button 58. Further, the right controller 4 includes a first R-button 60 and a ZR-button 61 in an upper right portion of a side surface of the housing 51. Further, similarly to the left controller 3, the right controller 4 includes a second L-button 65 and a second R-button 66.

Further, the right controller 4 includes a terminal 64 for allowing the right controller 4 to perform wired communication with the main body apparatus 2.

FIG. 6 is a block diagram illustrating a non-limiting example of an internal configuration of the main body apparatus 2. The main body apparatus 2 includes components 81 to 91, 97, and 98 illustrated in FIG. 6 in addition to the components illustrated in FIG. 3. Some of the components 81 to 91, 97, and 98 may be implemented as electronic parts on an electronic circuit board, which is contained in the housing 11.

The main body apparatus 2 includes a processor 81. The processor 81 is an information processor for executing various types of information processing to be executed by the main body apparatus 2. For example, the CPU 81 may include only a central processing unit (CPU), or may be a system-on-a-chip (SoC) having a plurality of functions such as a CPU function and a graphics processing unit (GPU) function. The processor 81 executes an information processing program (e.g., a game program) or other instructions that are stored in storage (e.g., an internal non-transitory storage medium such as a flash memory 84, an external non-transitory storage medium that is attached to the slot 23, or the like), thereby executing the various types of information processing.

The main body apparatus 2 includes a flash memory 84 and a dynamic random access memory (DRAM) 85 as examples of internal storage media built in itself. The flash memory 84 and the DRAM 85 are connected to the CPU 81. The flash memory 84 is mainly used to store various data (or programs) to be saved in the main body apparatus 2. The DRAM 85 is used to temporarily store various data used in information processing. The DRAM 85 and the flash memory 84 are illustrative non-limiting examples of non-transitory computer-readable media.

The main body apparatus 2 includes a slot interface (hereinafter abbreviated to “I/F”) 91. The slot I/F 91 is connected to the processor 81. The slot I/F 91 is connected to the slot 23, and reads and writes data from and to a predetermined type of storage medium (e.g., a dedicated memory card) attached to the slot 23, in accordance with commands from the processor 81.

The processor 81 reads and writes, as appropriate, data from and to the flash memory 84, the DRAM 85, and each of the above storage media, thereby executing the above information processing.

The main body apparatus 2 includes a network communication section 82. The network communication section 82 is connected to the processor 81. The network communication section 82 communicates (specifically, through wireless communication) with an external apparatus via a network. In the present embodiment, as a first communication form, the network communication section 82 connects to a wireless LAN and communicates with an external apparatus, using a method compliant with the Wi-Fi standard. Further, as a second communication form, the network communication section 82 wirelessly communicates with another main body apparatus 2 of the same type, using a predetermined communication method (e.g., communication based on a particular protocol or infrared light communication). It should be noted that the wireless communication in the above second communication form achieves the function of allowing so-called “local communication”, in which the main body apparatus 2 can wirelessly communicate with another main body apparatus 2 located in a closed local network area, and the plurality of main body apparatuses 2 directly communicate with each other to exchange data.

The main body apparatus 2 includes a controller communication section 83. The controller communication section 83 is connected to the processor 81. The controller communication section 83 wirelessly communicates with the left controller 3 and/or the right controller 4. The main body apparatus 2 may communicate with the left and right controllers 3 and 4 using any suitable communication method. In the present embodiment, the controller communication section 83 performs communication with the left and right controllers 3 and 4 in accordance with the Bluetooth (registered trademark) standard.

The processor 81 is connected to the left-side terminal 17, the right-side terminal 21, and the lower-side terminal 27. When performing wired communication with the left controller 3, the processor 81 transmits data to the left controller 3 via the left-side terminal 17 and also receives operation data from the left controller 3 via the left-side terminal 17. Further, when performing wired communication with the right controller 4, the processor 81 transmits data to the right controller 4 via the right-side terminal 21 and also receives operation data from the right controller 4 via the right-side terminal 21. Further, when communicating with the cradle, the processor 81 transmits data to the cradle via the lower-side terminal 27. As described above, in the present embodiment, the main body apparatus 2 can perform both wired communication and wireless communication with each of the left and right controllers 3 and 4. Further, when the unified apparatus obtained by attaching the left and right controllers 3 and 4 to the main body apparatus 2 or the main body apparatus 2 alone is attached to the cradle, the main body apparatus 2 can output data (e.g., image data or sound data) to a stationary monitor or the like via the cradle.

Here, the main body apparatus 2 can communicate with a plurality of left controllers 3 simultaneously (or in parallel). Further, the main body apparatus 2 can communicate with a plurality of right controllers 4 simultaneously (or in parallel). Thus, a plurality of users can simultaneously provide inputs to the main body apparatus 2, each using a set of left and right controllers 3 and 4. As a non-limiting example, a first user can provide an input to the main body apparatus 2 using a first set of left and right controllers 3 and 4, and at the same time, a second user can provide an input to the main body apparatus 2 using a second set of left and right controllers 3 and 4.

Further, the display 12 is connected to the processor 81. The processor 81 displays, on the display 12, a generated image (e.g., an image generated by executing the above information processing) and/or an externally obtained image.

The main body apparatus 2 includes a codec circuit 87 and speakers (specifically, a left speaker and a right speaker) 88. The codec circuit 87 is connected to the speakers 88 and an audio input/output terminal 25 and also connected to the processor 81. The codec circuit 87 is for controlling the input and output of audio data to and from the speakers 88 and the sound input/output terminal 25.

The main body apparatus 2 includes a power control section 97 and a battery 98. The power control section 97 is connected to the battery 98 and the processor 81. Further, although not illustrated, the power control section 97 is connected to components of the main body apparatus 2 (specifically, components that receive power supplied from the battery 98, the left-side terminal 17, and the right-side terminal 21). Based on a command from the processor 81, the power control section 97 controls the supply of power from the battery 98 to each of the above components.

Further, the battery 98 is connected to the lower-side terminal 27. When an external charging device (e.g., the cradle) is connected to the lower-side terminal 27, and power is supplied to the main body apparatus 2 via the lower-side terminal 27, the battery 98 is charged with the supplied power.

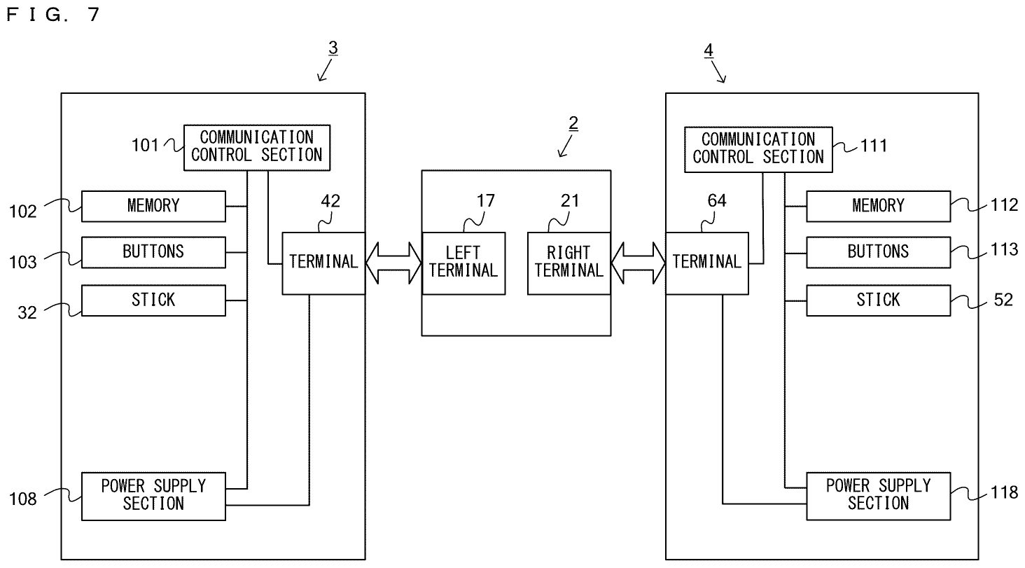

FIG. 7 is a block diagram illustrating non-limiting examples of the internal configurations of the main body apparatus 2, the left controller 3, and the right controller 4. It should be noted that the details of the internal configuration of the main body apparatus 2 are illustrated in FIG. 6 and therefore are omitted in FIG. 7.

The left controller 3 includes a communication control section 101, which communicates with the main body apparatus 2. As illustrated in FIG. 7, the communication control section 101 is connected to components including the terminal 42. In the present embodiment, the communication control section 101 can communicate with the main body apparatus 2 through both wired communication via the terminal 42 and wireless communication without via the terminal 42. The communication control section 101 controls the method for communication performed by the left controller 3 with the main body apparatus 2. That is, when the left controller 3 is attached to the main body apparatus 2, the communication control section 101 communicates with the main body apparatus 2 via the terminal 42. Further, when the left controller 3 is detached from the main body apparatus 2, the communication control section 101 wirelessly communicates with the main body apparatus 2 (specifically, the controller communication section 83). The wireless communication between the communication control section 101 and the controller communication section 83 is performed in accordance with the Bluetooth (registered trademark) standard, for example.

Further, the left controller 3 includes a memory 102 such as a flash memory. The communication control section 101 includes, for example, a microcomputer (or a microprocessor) and executes firmware stored in the memory 102, thereby performing various processes.

The left controller 3 includes buttons 103 (specifically, the buttons 33 to 39, 43, 44, and 47). Further, the left controller 3 includes the analog stick (“stick” in FIG. 7) 32. Each of the buttons 103 and the analog stick 32 outputs information regarding an operation performed on itself to the communication control section 101 repeatedly at appropriate timing.

The communication control section 101 acquires information regarding an input (specifically, information regarding an operation or the detection result of the sensor) from each of input sections (specifically, the buttons 103 and the analog stick 32). The communication control section 101 transmits operation data including the acquired information (or information obtained by performing predetermined processing on the acquired information) to the main body apparatus 2. It should be noted that the operation data is transmitted repeatedly, once every predetermined time. It should be noted that the interval at which the information regarding an input is transmitted from each of the input sections to the main body apparatus 2 may or may not be the same.

The above operation data is transmitted to the main body apparatus 2, whereby the main body apparatus 2 can obtain inputs provided to the left controller 3. That is, the main body apparatus 2 can determine operations on the buttons 103 and the analog stick 32 based on the operation data.

The left controller 3 includes a power supply section 108. In the present embodiment, the power supply section 108 includes a battery and a power control circuit. Although not illustrated in FIG. 7, the power control circuit is connected to the battery and also connected to components of the left controller 3 (specifically, components that receive power supplied from the battery).

As illustrated in FIG. 7, the right controller 4 includes a communication control section 111, which communicates with the main body apparatus 2. Further, the right controller 4 includes a memory 112, which is connected to the communication control section 111. The communication control section 111 is connected to components including the terminal 64. The communication control section 111 and the memory 112 have functions similar to those of the communication control section 101 and the memory 102, respectively, of the left controller 3. Thus, a communication control section 111 can communicate with the main body apparatus 2 through both wired communication via the terminal 64 and wireless communication without via the terminal 64 (specifically, communication compliant with the Bluetooth (registered trademark) standard). The communication control section 111 controls the method for communication performed by the right controller 4 with the main body apparatus 2.

The right controller 4 includes input sections similar to the input sections of the left controller 3. Specifically, the right controller 4 includes buttons 113 and the analog stick 52. These input sections have functions similar to those of the input sections of the left controller 3 and operate similarly to the input sections of the left controller 3.

The right controller 4 includes a power supply section 118. The power supply section 118 has a function similar to that of the power supply section 108 of the left controller 3 and operates similarly to the power supply section 108.

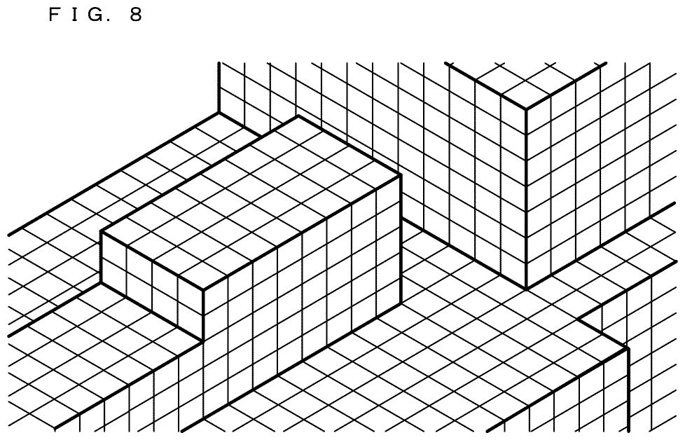

Next, referring to FIG. 8 to FIG. 15, an outline of the process performed on the game system 1 will be described. In the present embodiment, the game system 1 generates a game image in which terrain objects and characters (e.g., a player character that is controlled by the player) are arranged in a game space, which is a three-dimensional virtual space, and displays the game image on a display device. Note that in the present embodiment, the display device on which the game image is displayed may be the display 12 described above, or may be a stationary monitor.

In the present embodiment, for some objects in the game space, the shape is defined by voxel data. Here, voxels are rectangular parallelepiped (more specifically, cubic) regions arranged in a grid pattern in the game space, and voxel data is data that is set for each voxel. Hereinafter, an object whose shape is defined by voxel data will be referred to as a “voxel object”. In the present embodiment, the game system 1 stores voxel data for each of a plurality of voxels that are set in the game space as data for generating voxel objects in the game space.

FIG. 8 is a view showing an example of a terrain object, which is a voxel object. As shown in FIG. 8, in the present embodiment, a terrain object representing a terrain such as a ground surface has its shape defined by voxel data. The cubes shown in FIG. 8 represent a terrain object. Note that in FIG. 8, edges of the terrain object are indicated by thick lines. However, the thick lines are added for the purpose of making the drawings easier to understand, and there is actually no need for edges of the terrain object to be drawn thick.

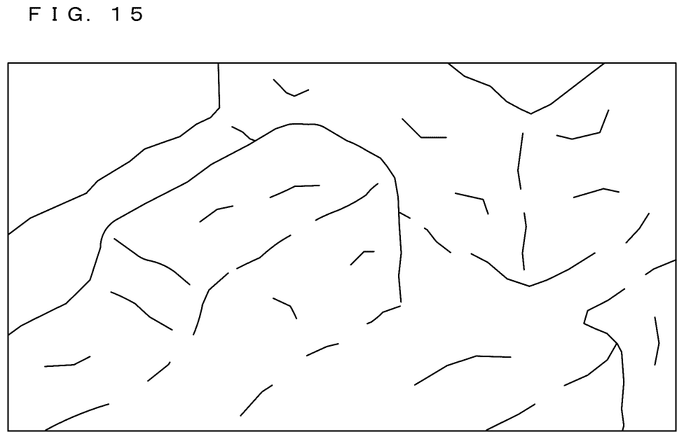

For example, the terrain object shown in FIG. 8 is generated by the following rule: “a cube is placed at the position of a voxel if a parameter included in the voxel data set for the voxel is greater than a predetermined value, and nothing is placed at the position of the voxel if the parameter is less than or equal to the predetermined value”. The terrain object shown in FIG. 8 is shown for the purpose of illustrating the relationship between voxels and voxel objects in an easy-to-understand manner. Note however that in the present embodiment, in practice, a voxel object is generated by such a rule (e.g., based on the voxel data) that results in a terrain object having a complicated shape in comparison with the cubic voxels, such as a terrain object shown in FIG. 15 to be described below, for example. Note that there is no limitation on the rule for determining the shape of the voxel object based on the voxel data. In other embodiments, the game system 1 may generate a voxel object as shown in FIG. 8 based on the object data or may generate a voxel object as shown in FIG. 15 based on the object data.

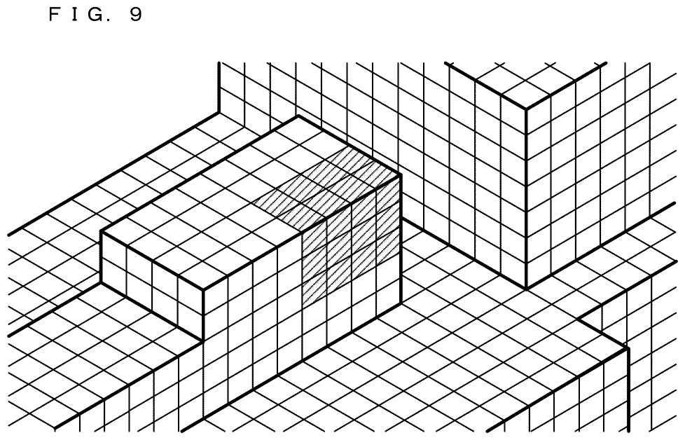

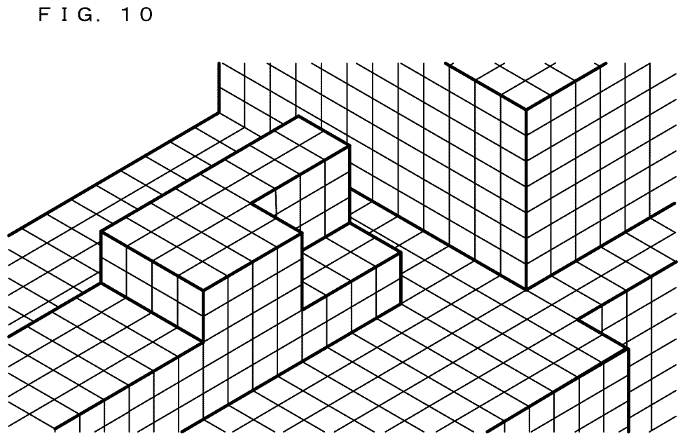

It is possible to change the shape of a voxel object by changing voxel data of voxels. FIG. 9 and FIG. 10 are views showing before and after the removal of a portion of the terrain object shown in FIG. 8. That is, when the hatched portion of the terrain object shown in FIG. 9 is broken, the terrain object changes to a shape as shown in FIG. 10. In such a case, the game system 1 can easily delete the terrain object by rewriting voxel data to be described below so as to indicate that the terrain object is absent for voxels in the hatched portion. Note that also when making an addition to the terrain object, as when deleting the terrain object, the game system 1 can easily change the shape of the terrain object by changing the voxel data of voxels.

Thus, the game system 1 can freely change the shape of a voxel object by rewriting the voxel data. For example, when the shape of a terrain object may be changed as a result of the terrain object in a game being broken for some reason (e.g., the player character striking the terrain object), the game system 1 can freely change the shape of the terrain object by changing the voxel data used to generate the terrain object, rather than directly changing data representing the outer shape of the terrain object (e.g., the mesh to be described below).

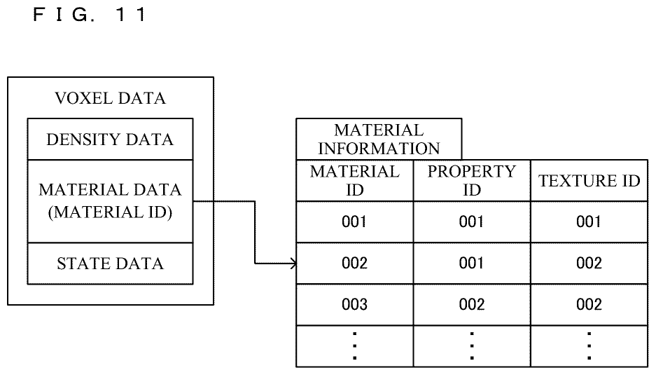

FIG. 11 is a diagram showing an example of content of voxel data. Here, in the present embodiment, the game space can be divided into a plurality of voxels arranged in a grid pattern. The game system 1 stores voxel data for each voxel in the game space so that the voxel data is associated with the voxel. The voxel data represents, for example, the presence/absence of a voxel object in the voxel corresponding to the voxel data.

As shown in FIG. 11, voxel data includes density data. The density data represents a density that indicates the degree to which an object is included in a region defined by each voxel. As will be described in detail below, the position and the shape of the surface of the voxel object (e.g., the mesh to be described below) are determined based on this density. In other words, in the present embodiment, this density is also data that is used to generate a mesh that defines the surface of the voxel object.

In the present embodiment, the density can take an integer value in the range from the lower limit value (e.g., 0) to the upper limit value (e.g., 255). In the present embodiment, in the game system 1, the proportion of the volume to be occupied by the voxel object in a voxel tends to be higher when the density value set for the voxel is higher, and the proportion in a voxel tends to be lower when the density value is lower. For example, if the density is 0, there is no voxel object in the voxel, if the density is 255, the inside of the voxel is entirely the object, and if the density is between 0 and 255, the inside of the voxel is occupied by the object to the proportion that is determined based on the density value. Then, the shape of the voxel mesh, e.g., the shape of the voxel object, is determined based on the density. Note however that the shape of the voxel object generated based on the density does not need to have a volume that exactly matches the proportion represented by the density. For example, the method of generating a voxel object as shown in FIG. 8 and the method of generating a voxel object as shown in FIG. 15 may differ in the volume of the voxel object, even if they are based on the same density.

Note that in other embodiments, the density may indicate either a state in which the voxel object occupies the entirety of the region within the voxel or a state in which no voxel object is included in the region within the voxel. For example, the density data may be data that can take only one of 0 or 1.

As shown in FIG. 11, voxel data includes material data. The material data represents the material (in other words, the substance) of the voxel object generated by the voxel data. Here, in the present embodiment, materials such as sand, rock and soil, for example, are set for voxel objects. That is, in the present embodiment, a plurality of types of materials are provided as materials that can be set for a voxel object, and one of the materials is set for a voxel object.

As shown in FIG. 11, in the present embodiment, the material data represents the identification information of the material (referred to as “material ID”). In the present embodiment, the game system 1 stores material information representing the property and the texture of the material for each material provided in the game. In the present embodiment, the material information represents associations between the material ID, the property of the material and the appearance (specifically, the texture) of the material. Specifically, the material information is information that represents associations between the material ID, identification information of the property of the material (referred to as “property ID”) and identification information of the texture of the material (referred to as “texture ID”) (see FIG. 11).

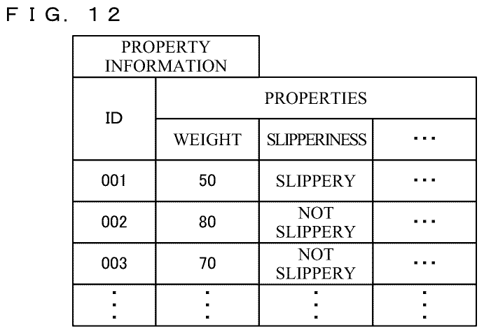

FIG. 12 is a diagram showing an example of property information representing properties of materials. As shown in FIG. 12, the game system 1 stores property information that associates each property ID with information that represents the content of the property represented by the property ID. A property of a material is a property of a voxel object for which the material is set in the game, and it may be information such as weight or slipperiness shown in FIG. 12, for example. Note that there is no limitation on the specific content of the property. For example, the following information may be set as properties of a material.
Temperature
Breakability (e.g., the number of times of impact impartation needed to break a voxel object)
Whether another object can be bonded to a voxel object
Amount of hit points to be regained by the player character when the player character breaks a voxel object
Amount of in-game currency to be gained by the player character when the player character breaks a voxel object

Note that there is no limitation on the specific content of the property to be set for a material. In other embodiments, information different from those listed above may be set as information that represents a property of a material.

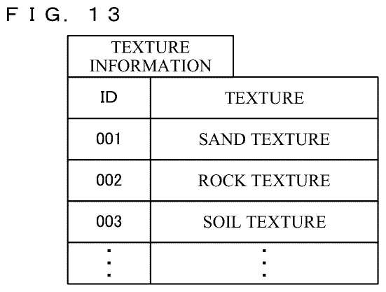

FIG. 13 is a diagram showing an example of texture information representing textures of materials. As shown in FIG. 13, the game system 1 stores texture information that associates the texture ID with the texture represented by the texture ID.

Note that in addition to information of texture, any information regarding the color and/or pattern may be set as data that defines the appearance of a voxel object. For example, a pattern of cracks may be set as information regarding the appearance of a voxel object. By using such a pattern, the game system 1 can generate an image of a voxel object that represents the appearance of cracks.

As described above, in the present embodiment, the material data defines, by the material ID, the property of the voxel object and the texture used for the voxel object. For example, when the material ID represented by the material data included in the voxel data is “002”, the property represented by the property ID “001” that is associated with the material ID in the material information is set as the property of the voxel object corresponding to the voxel data (see arrow shown in FIG. 11). In this case, the texture that is represented by the texture ID “002” associated with the material ID in the material information is applied to the voxel object corresponding to the voxel data (see arrow shown in FIG. 11).

As described above, in the present embodiment, the game system 1 separately manages the property and the texture of the material. Therefore, in the present embodiment, it is possible to easily set a plurality of types of materials having the same property but having different appearances (e.g., different textures) or set a plurality of types of materials having different properties but having the same appearance.

Note that the material data may be any data with which it is possible to identify the property and/or the texture of the material. For example, in other embodiments, the material data may represent the property ID and the texture ID, or may have a data structure that actually includes data representing the property and the texture of the material.

The material data may further represent information related to the material other than the property and the texture described above. For example, the material data may include special effect data that represents the special effect to be triggered upon satisfaction of a special effect triggering condition set for the voxel object (e.g., a portion of the voxel object being broken, or the character stepping on the voxel object). Note that the special effect data may be data that represents a special effect image (e.g., a special effect image showing the voxel object being broken), or may be data that represents a special effect sound (a sound of footstep when the character walks on the voxel object).

As shown in FIG. 11, the voxel data includes state data that represents the state of the voxel object. There is no limitation on the specific content of the state data. For example, the state data may be data that represents whether the voxel object is in a wet state, or may be data that represents the amount of damage applied to the voxel object. The content of the state data may be updated during the game.

In the present embodiment, the surface of the voxel object is represented by a mesh. A mesh is a set of faces (specifically, polygons) placed in the game space. In the present embodiment, the game system 1 generates a mesh for the voxel object based on the voxel data of each voxel set in the game space. An example of how a mesh is generated based on voxel data will now be described.

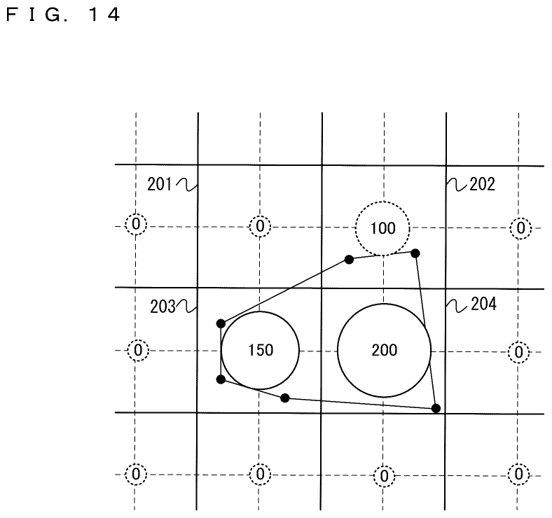

FIG. 14 is a diagram showing an example of a method for generating a mesh. Note that in FIG. 14, voxels and meshes are represented in two dimensions for the purpose of making the drawing easier to understand and for the sake of discussion, but in practice, a three-dimensional mesh is generated based on voxels in a three-dimensional space.

As described above, in the present embodiment, the density set for the voxel is in the range of 0 to 255. In the present embodiment, voxels with densities equal to or greater than the reference value are considered to be inside the voxel object, and voxels with densities less than the reference value are considered to be outside the voxel object. It is not necessary to define only voxels with a density of 0 as being outside the voxel object (e.g., reference value=1), and the reference value may be set to 128, for example. In the example shown in FIG. 14, a voxel 201 and the other outer voxels have a density of 0, a voxel 202 has a density of 100, which is less than the reference value, and voxels 203 and 204 have densities of 150 and 200, which are greater than the reference value. In the present embodiment, the game system 1 generates vertices between those voxels whose densities are equal to or greater than the reference value and those voxels whose densities are less than the reference value. Specifically, for each region (region delimited by dotted lines) that straddles eight (four in the figure) adjacent voxels, it is determined whether or not to generate a vertex. That is, a vertex is generated in each region that straddles both a voxel whose density is equal to or greater than the reference value and a voxel whose density is less than the reference value. Then, a polygon mesh is generated by connecting together adjacent vertices if the connection (the boundary between the regions including the vertices) passes through a voxel whose density is equal to or greater than the reference value and a voxel whose density is less than the reference value.

The coordinates of each vertex are determined by comparing densities of adjacent voxels and interpolating based on the difference in density for each of the XYZ axes. In this process, the coordinates can be further calculated based on the normal information. The normal information may be stored in advance for at least some of the voxels, or if not stored, the normal information may also be calculated based on densities between adjacent voxels. Note that in FIG. 14, the density of the voxel 202 is less than the reference value, the voxel 202 is treated as being outside the voxel object in the determination of the presence/absence of a vertex, but the density value itself of the voxel 202 is used to calculate the coordinates of the vertices generated. If the reference value were set to a value lower than the density of the voxel 202, it would result in an increase in the vertices on the upper right side and the upper left side in the voxel 202 of FIG. 14.

By generating a polygon mesh as described above, it is possible to generate a shape whose volume reflects the density of each voxel to some extent. Note however that depending on the relationship with neighboring voxels, it is possible that a voxel with a density of 0 may partially include a region inside the voxel object, or a voxel with a density of 255 may partially include a region outside the voxel object. Since voxels with densities less than the reference value are treated as being outside the voxel object in the present embodiment, there are fewer vertices as compared with a case where those voxels are treated as being inside the voxel object, the volume will be smaller accordingly. That is, there is no need to calculate the polygon mesh so that the volume strictly corresponds to the density value.

FIG. 15 shows an example of a game image including a terrain object. In the present embodiment, by generating a mesh as described above, the voxel object can be made in a shape with complicated irregularities compared to the cubic voxels, for example.

Note that there is no limitation on the method of generating a mesh based on voxel data. For example, in other embodiments, if the density of the voxel data is greater than a predetermined value, a mesh may be generated so that a cube is placed in the voxel (see FIG. 8).

For each face of the mesh generated as described above, the game system 1 determines the appearance (e.g., color and/or pattern) of each such face according to the material identified by the voxel data. Specifically, the game system 1 determines the texture to be used for rendering each face of the mesh based on the voxel data, and maps the determined texture to each face to generate an image of the voxel object. Note that the texture to be mapped to each face of the mesh is determined based on the voxel data of the voxel used to generate the face (which will be referred to as the target voxel) among the voxels where the voxel object exists. Note that the target voxel is, for example, one or more voxels located around the face, although it depends on the mesh generation method. That is, the texture mapped to a face of the mesh is determined to be a texture corresponding to the material set for one or more voxels placed around the face.

Note that in other embodiments, one voxel data may include multiple types (e.g., two types) of material data. In such a case, the voxel data includes ratio data related to the multiple types of material data. The ratio data is data for determining the texture to be used for the voxel object, and represents the ratio by which each of the materials (specifically, the texture corresponding to the material) represented by the multiple types of material data influences the appearance (specifically, the color and/or pattern) of the voxel object. When determining the texture to be mapped to each face of the mesh, the texture is determined based on various data (specifically, density data, multiple types of material data and ratio data) included in the voxel data of the target voxel. For example, when multiple types of materials are set for a target voxel corresponding to one face, a texture corresponding to the (one type of) material with the greatest degree of influence may be used while taking the ratio into consideration, or textures corresponding to multiple types of materials may be used while taking the ratio into consideration.

In other embodiments, there may be both voxel objects for which voxel data including one type of material data is used, and voxel objects for which voxel data including two types of material data is used.

As described above, in the present embodiment, the game system 1 sets the color and/or pattern of the mesh of the voxel object based on appearance data (specifically, a texture ID representing a texture) that defines the color and/or pattern of the voxel object for each voxel. Specifically, for a mesh to be generated based on voxel data of a certain voxel, among meshes of voxel objects, the game system 1 applies the texture represented by the appearance data for the voxel to the mesh of the voxel object that is generated based on the voxel data for the certain voxel. Thus, it is possible to set the color and/or pattern of the voxel object using the appearance data set for the voxel.

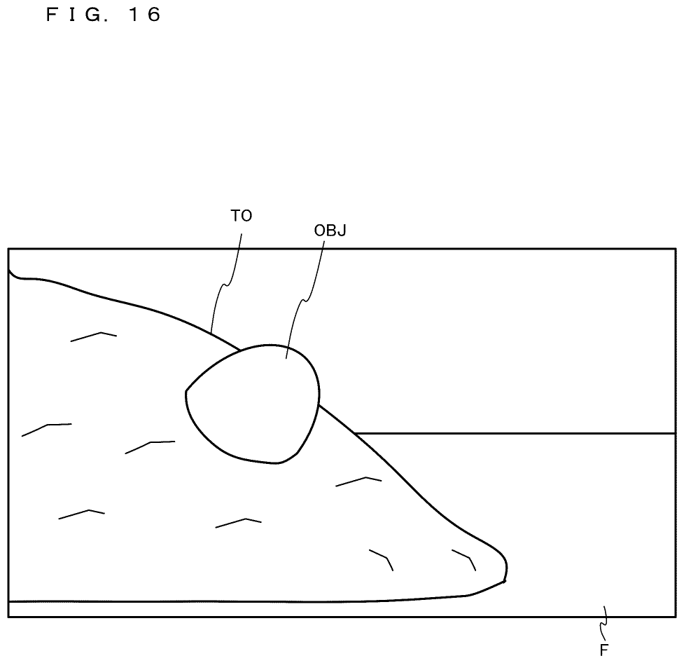

Next, an example of game play in which a player character is operated in a game space according to the user's operation performed on the game system 1 will be described with reference to FIGS. 16 to 21. For example, in the present example, a player character PC appearing in the game space displayed on the display 12 is operated according to the user's operation performed on the operation buttons and sticks of the left controller 3 and/or the right controller 4 of the game system 1 in the unified form, the user's touch operation performed on the touch panel 13 of the main body apparatus 2, the user's operation of moving the entire game system 1 or changing the orientation of the game system 1, and the like.

FIG. 16 is a diagram showing an example of a game image on the display 12 showing a buried object OBJ that is partially buried in a terrain object TO. In FIG. 16, the terrain object TO is an example of a voxel object that is generated based on the above voxel data, and a surface of which is represented by a mesh. In the example of FIG. 16, a voxel space in which voxels are specified is set on the game field F in the game space, and the terrain object TO is generated on the game field F by a plurality of voxels specified in the voxel space. Here, at least one voxel space is set in at least a portion of the game space in order to specify a plurality of voxels. For each voxel space, the length (resolution) of an edge of a voxel, the vectors (orientations) of the x-, y-, and z-axes of a global coordinate system in a vector space, the length of the voxel space in each of the x-, y-, and z-directions, and a location of the voxel space in the game space, and the like are specified. Although FIG. 16 shows an example in which an object is rendered by generation of a mesh having an appearance as shown in FIG. 15 using the technique described with reference to FIG. 14, an object may be rendered by a block mesh as shown in FIG. 9 or 10.

In the present example, the buried object OBJ may be buried in at least a portion of the terrain object TO. For example, the buried object OBJ is a virtual object such as a fossil, which can be unearthed from the terrain object TO by the player character PC, which is operated by the user. The buried object OBJ is generated based on a polygon model that is not based on voxel data, voxel data in a voxel space different from the terrain object TO, or the like. When the player character PC unearths the buried object OBJ, the player character PC can obtain the buried object OBJ thus unearthed itself, or an item or the like associated with that buried object OBJ.

In the example of a game image shown in FIG. 16, the buried object OBJ is partially buried in the terrain object TO with a portion thereof exposed from an external surface of the terrain object TO. Note that the buried object OBJ may be completely buried in the terrain object TO. The buried object OBJ thus buried in the terrain object can be unearthed if a predetermined excavation condition is satisfied by removing the terrain object TO around the buried object OBJ. In the present example, at least a portion of the terrain object TO can be broken and removed by the player character PC performing an action of breaking the terrain object TO. When the player character PC performs a breaking action of breaking the terrain object TO such that the terrain object TO around the buried object OBJ is removed, the buried object OBJ may be unearthed by the breaking action and may be possessed by the player character PC.

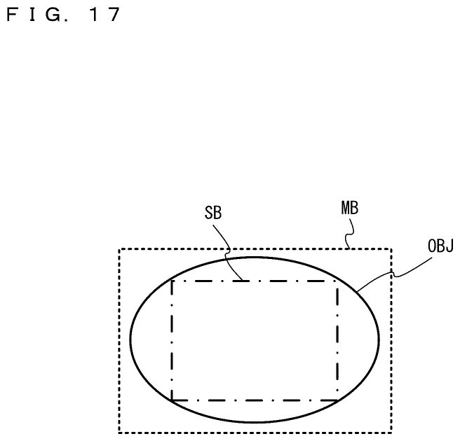

FIG. 17 is a diagram for describing an example of a small box SB and a main box MB that are set for the buried object OBJ. The buried object OBJ has a three-dimensional shape. In FIG. 17, the buried object OBJ is an ellipsoidal, three-dimensional object, for example. For the buried object OBJ, the small box SB is set. The small box SB is used in order to form, in the terrain object TO, a hole or cavity for burying and fixing the buried object OBJ. The small box SB is formed in the shape of a rectangular cuboid that can be included in the buried object OBJ. Note that the shape of the small box SB may have a size such that the small box SB is included in the buried object OBJ with a plurality of vertices thereof in contact with a surface of the buried object OBJ, or with none of the vertices thereof in contact with a surface of the buried object OBJ.

For the buried object OBJ, the main box MB is also set. The main box MB is used to determine whether or not the buried object OBJ is covered by the terrain object TO, and whether or not the buried object OBJ is supported by the terrain object TO. The main box MB has a basic shape that can include the buried object OBJ. For example, the main box MB is formed in the shape of a rectangular cuboid including the buried object OBJ. The main box MB may have a size such that the main box MB includes the buried object OBJ with a plurality of points on an external surface of the buried object OBJ in contact with an internal surface of the main box MB so that a space therebetween is minimized, or a size such that the main box MB includes the buried object OBJ with no points on the external surface of the buried object OBJ in contact with the internal surface of the main box MB. As an example, the main box MB is set as a bounding box with respect to the buried object OBJ, or a directed bounding box or an axis-aligned bounding box (AABB) parallel to the coordinate axes of the game space with respect to the buried object OBJ. Note that the main box MB corresponds to an example of a first determination shape that is a shape of an object or a basic shape including the object.

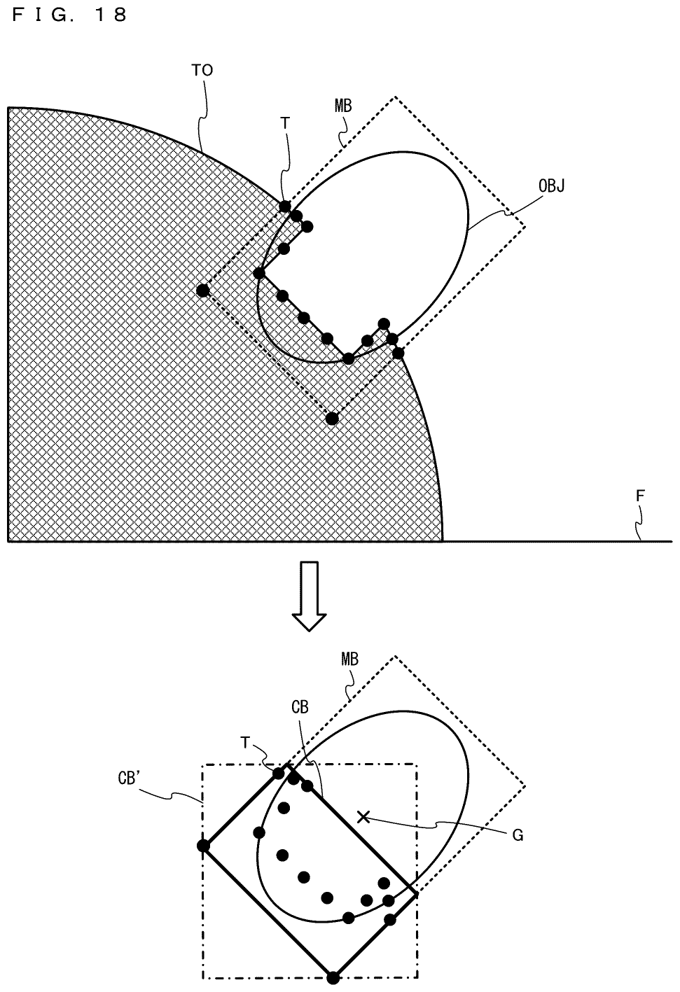

FIG. 18 is a vertical cross-sectional view showing an example of a state of a buried object OBJ buried in and fixed to the terrain object TO. In FIG. 18, a hole having the shape of the small box SB set in the buried object OBJ is formed at a surface of the terrain object TO. The buried object OBJ is buried in the hole of the terrain object TO, depending on a location and orientation of the hole having the shape of the small box SB. Here, whether or not at least a portion of the buried object OBJ is buried in and fixed to the terrain object TO is determined based on first determination and second determination.

The first determination is to determine whether or not the buried object OBJ is covered by the terrain object TO. Initially, in the first determination, a contact site(s) where the main box MB of the buried object OBJ is in contact with the terrain object TO is identified. In the example of FIG. 18, a plurality of contact points T between the inside of the main box MB and the surface of the terrain object TO are identified as a contact site. For example, points included in a portion included the inside of the main box MB on a mesh formed at the surface of the terrain object TO are each identified as a contact point T. Furthermore, some of the vertices of the main box MB that are in contact with the terrain object TO are additionally identified as a contact point T. Note that the above points on a mesh may be a vertex of a polygon included in the mesh, or a representative point of the surface of the polygon. Note that the identification of a contact site in the present example includes an embodiment that a contact site is newly calculated and set, and an embodiment that the validity of a contact site already set is verified. Note that contact sites may be identified by a plurality of contact points T between the inside of the main box MB and the surface of the terrain object TO (e.g., no vertices of the main box MB that are in contact with the terrain object TO are included).

Note that for contact points T, other contact sites may be identified. As an example, in the case where, as in the above example, a contact site between the main box MB of the buried object OBJ and the terrain object TO is identified, a plurality of contact points on the surface of the main box MB that are located inside the terrain object TO may be identified as a contact site. As another example, a contact site between the buried object OBJ and the terrain object TO may be identified. In that case, as a first example, a plurality of contact points between the surface of the buried object OBJ and the inside of the terrain object TO may be identified as a contact site. As a second example, a plurality of contact points between the inside of the buried object OBJ and the surface of the terrain object TO may be identified as a contact site.

Next, in the first determination, a cover box CB that includes the contact sites is set. The cover box CB is formed in a basic shape that can include all contact points T. For example, the cover box CB may be in the shape of a rectangular cuboid having a size such that the cover box CB includes the contact points T with at least one contact point T in contact with the internal surface of the cover box CB so that a space between the cover box CB and each contact point Tis minimized, or such that the cover box CB includes the contact points T with no contact points T in contact with the internal surface of the cover box CB. As an example, the cover box CB is a bounding box for a plurality of contact points T such as a directed bounding box having surfaces parallel to the respective surfaces of the main box MB or an axis-aligned bounding box parallel to the coordinate axes of the game space. Note that the cover box CB may be a directed bounding box for a plurality of contact points T that is set independently of the orientation of the main box MB and the coordinate axes of the game space. The cover box CB corresponds to an example of a second determination shape that is a basic shape including contact sites.

Next, in the first determination, a volume ratio (cover ratio) of the cover box CB and the main box MB is calculated. If the cover ratio is higher than a threshold, it is determined that the buried object OBJ is covered by the terrain object TO. If it is determined that the buried object OBJ is covered by the terrain object TO, it is assumed that the buried object OBJ is buried in and fixed to the terrain object TO. For example, the cover ratio is calculated by dividing the volume of the cover box CB by the volume of the main box MB. As the cover ratio increases, the proportion of the buried object OBJ covered by the terrain object TO increases. Note that the cover ratio may be calculated by dividing the surface area of the cover box CB by the surface area of the main box MB.

The second determination is to determine whether or not the buried object OBJ is supported by the terrain object TO. If it is determined that the buried object OBJ is supported by the terrain object TO, then even when the result of the first determination is negative, it is assumed that a portion of the buried object OBJ is buried in, fixed to, and supported by the terrain object TO. In the second determination, it is determined whether or not the buried object OBJ is supported by the terrain object TO, based on a positional relationship between the centroid of the main box MB and the cover box CB. In this case, in an example that the cover box CB is not an axis-aligned bounding box parallel to the coordinate system of the game space, a cover box CB′ that is an axis-aligned bounding box for the cover box CB is calculated, and the determination is performed based on a positional relationship between the centroid of the main box MB and the cover box CB'. For example, if the cover box CB or the cover box CB' includes the centroid of the main box MB in terms of the components other than the height direction of the game space, and at least a portion of the cover box CB or the cover box CB' is located lower than the centroid of the main box MB in terms of the height direction, it is determined that the buried object OBJ is supported by the terrain object TO. As an example, if the centroid of the main box MB is included in the cover box CB' or the cover box CB is placed in the vertical direction in the game space of the centroid of the main box MB, it is determined that the buried object OBJ is supported by the terrain object TO. The cover box CB' corresponds to an example of a third determination shape including the second determination shape.

If the results of the first determination and the second determination are both negative, the buried object OBJ drops from the location thereof in the terrain object TO, e.g., the buried object OBJ is not fixed to the terrain object TO. Note that if the result of the first determination is negative and the result of the second determination is positive, a portion of the buried object OBJ is buried in and fixed to the terrain object TO. When an impact greater than or equal to a threshold is subsequently applied to the buried object OBJ, the buried object OBJ may drop from the terrain object TO. Note that the threshold may be a predetermined invariable value, or a value varying depending on the cover ratio of the buried object OBJ (the value decreases with a decrease in the cover ratio). The impact that is applied on the buried object OBJ may occur when an action of breaking the terrain object TO is performed.

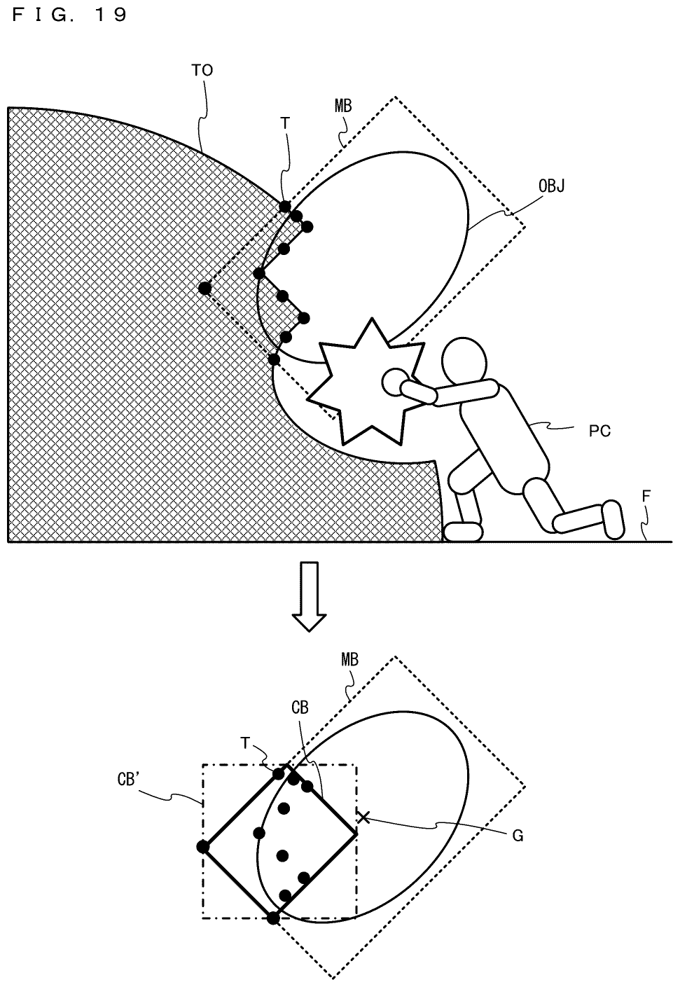

The buried object OBJ may drop from the terrain object TO when the player character PC, which performs an action according to the user's operation, breaks the terrain object TO around the buried object OBJ. FIG. 19 is a diagram showing an example of a game image showing that the player character PC performs an action of breaking a portion of the terrain object TO.

In FIG. 19, the player character PC is performing a breaking action such as punching on the terrain object TO formed below the buried object OBJ according to the user's operation. In the present example, when the player character PC performs an action of breaking the terrain object TO, a portion of the terrain object TO may be broken and removed. As an example, when the player character PC performs an action of punching a portion of the terrain object TO as shown in FIG. 19, the terrain object TO may be broken such that a portion of the terrain object TO is deformed and removed.

As shown in FIG. 19, a portion of the terrain object TO is deformed and removed from the game space due to the player character PC's breaking action. Specifically, for the terrain object TO formed below the buried object OBJ, a bell-shaped destruction range having a semi-spherical shape at a deepest portion lost due to the player character PC's breaking action is formed.

Thus, when a portion of the terrain object TO is removed due to destruction, a determination process concerning whether or not the buried object OBJ is buried and fixed is newly executed for the terrain object TO in which the state of voxels have been changed. In the present example, when editing such as removal is performed on voxels in which the buried object OBJ is buried, the presence or absence and deformation of voxels in the vicinity of the contact points T constituting the buried object OBJ are checked. When editing such as removal or deformation of the voxels has been performed, the contact points T of the voxels are changed, and the cover box CB is updated, and the first determination and the second determination are newly executed. Note that the change of contact points T by editing voxels may be only removal of the contact points T of removed voxels, or new identification of contact points T using a mesh newly formed using edited voxels.

For example, when the terrain object TO around the buried object OBJ is removed or deformed due to destruction as shown in the example of FIG. 19, contact sites between the main box MB of the buried object OBJ and the terrain object TO are changed, and therefore, the results of the first determination and the second determination may be changed. For example, in the example of FIG. 19, the terrain object TO supporting a lower portion of the buried object OBJ is removed compared to the state of FIG. 18, and therefore, the locations of contact points T below the lower portion are changed, resulting in a change in the shape and size of the cover box CB. Therefore, the cover ratio may be changed to be lower than or equal to the threshold, so that in the first determination, it is determined that the buried object OBJ is not covered by the terrain object TO.

In the example of FIG. 19, in the second determination, the cover box CB' is not located in the vertical direction in the game space of the centroid of the main box MB, and therefore, it is determined that the buried object OBJ is not supported by the terrain object TO. Therefore, if it is determined in the first determination that the cover ratio is lower than or equal to the threshold, and it is determined in the second determination that the cover box CB' is not located in the vertical direction in the game space of the centroid of the main box MB, it is assumed that the buried object OBJ is not fixed to the terrain object TO.

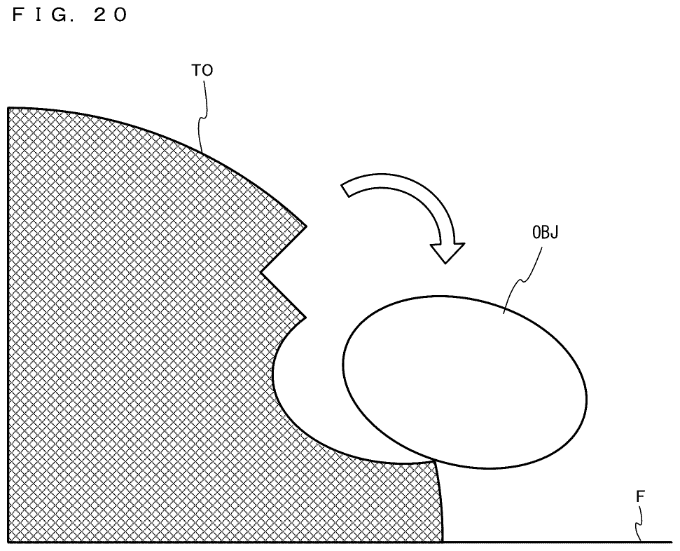

Thus, if it is determined that the buried object OBJ is not fixed to the terrain object TO, the buried object drops from the location thereof in the terrain object TO. For example, as shown in FIG. 20, the buried object OBJ drops from the location where the buried object has been buried in the terrain object TO, toward the game field F, in accordance with a physical law set in the game space. The buried object OBJ which has dropped can be unearthed by the player character PC performing a predetermined action, or automatically. The player character PC may obtain the buried object OBJ itself or an item associated with the buried object OBJ by the unearthing action.

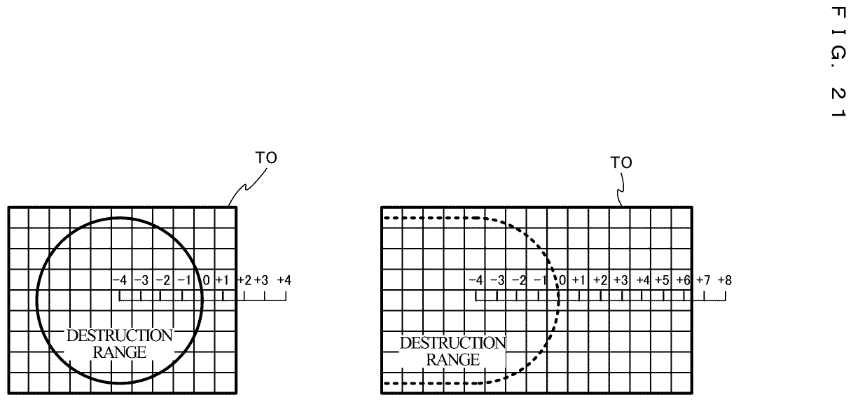

In the present example, by changing the voxel data of the voxels constituting the terrain object TO, the process of how the terrain object TO is broken and deformed/removed can be represented. FIG. 21 is a diagram showing an example of a destruction range of voxels to be broken in a terrain object TO. Note that the left figure of FIG. 21 shows the front surface (surface to be broken) of the terrain object TO as viewed from the player character PC, which breaks the terrain object TO. The right figure of FIG. 21 shows the right side surface of the terrain object TO shown in the left figure.

The destruction range of the terrain object TO to be broken by the player character PC's breaking action is set based on the location where the player character PC breaks the terrain object TO, the player character PC's strength and capability, and the strength (material) of the terrain object TO. For example, the destruction range is set such that a distance from a reference location set based on a location where the player character PC has performed a breaking action in the game space is within a predetermined distance. In the example of FIG. 21, for the terrain object TO, a bell-shaped destruction range having a semi-spherical shape at a deepest portion lost due to the destruction is formed around the location where the player character PC has performed a breaking action. Note that the shape of the destruction range may be other shapes such as a sphere, ellipsoid, cube, cylinder, wedge, shapes generated by 3D software, and in addition, these shapes a portion of which has been removed, and the like. The destruction range may be located around a location where the player character PC has performed a breaking action (e.g., a location where the player character PC's punching fist has reached) in the game space, or around a location at a predetermined distance in front of said location as viewed from the player character PC.

A voxel to be removed/deformed with reference to the above destruction range is determined using a signed distance field (SDF). The SDF of a voxel indicates a distance between the voxel and a surface of the destruction range closest to that voxel. It is assumed that the SDF of a voxel located on a surface of the destruction range is zero, the SDF of a voxel located outside the destruction range is positive, and the SDF of a voxel located inside the destruction range is negative. A removal/deformation process is set for each voxel, depending on the SDF of the voxel. For example, for a voxel to be removed, a portion of the terrain object TO that corresponds to the voxel is removed by rewriting the voxel data of the voxel such that the voxel data indicates the absence of a terrain object.

For example, in the present example, removal/deformation of a voxel is controlled by changing a density included in the voxel data thereof. For example, the density is an index indicating the proportion of the volume of a voxel object to a region defined by a voxel. The density can take an integer value in the range from the lower limit value (e.g., 0) to the upper limit value (e.g., 255). It is assumed that the higher the value of the density set for a voxel, the greater the proportion in the voxel, and the lower the value of the density, the smaller the proportion in the voxel. It is also assumed that no voxel object is included in a voxel the value of the density of which is the lower limit (e.g., 0), and a voxel object is included throughout a voxel the value of the density of which is the upper limit value (e.g., 255). In other words, if the value of the density is greater than the lower limit value, the voxel data indicates the presence of a terrain object, and if the value of the density is the lower limit value, the voxel data indicates the absence of a terrain object. Note that the shape of a voxel mesh generated based on the density does not need to have a volume exactly corresponding to the value of the density.

In the present example, removal/deformation of a voxel is controlled by rewriting the density of the voxel based on the SDF of the voxel. Specifically, by rewriting and reducing the densities of at least voxels having a negative SDF distance, at least a portion of the voxels included in the destruction range are changed to the state in which no terrain object is present. As a first example, by rewriting the densities of voxels having a negative SDF distance to the lower limit value, the voxels, which are included in the destruction range, are set to the state in which no terrain object is present, and by maintaining the values of the densities of voxels having a positive SDF distance unchanged, the voxels, which are out of the destruction range, are set to the state in which a terrain object is present. As a second example, by rewriting the densities of voxels having a negative SDF distance such that the value of the density of the voxel decreases with an increase in the absolute value of the distance, and rewriting the densities of voxels whose absolute value is greater than a predetermined value to the lower limit value, a portion of the voxels, which are included in the destruction range, are set to the state in which no terrain object is present, and by maintaining the values of the densities of voxels having a positive SDF distance unchanged, the voxels, which are out of the destruction range, are set to the state in which a terrain object is present. As a third example, by rewriting the densities of voxels having a negative SDF distance to the lower limit value, the voxels, which are included in the destruction range, are set to the state in which no terrain object is present, and by rewriting the densities of voxels having a positive SDF distance such that the value of the density of the voxel decreases with a decrease in the absolute value of the distance, a portion of the voxels, which are out of the destruction range, are set to the state in which the voxel is not entirely occupied by a voxel object.

Note that when the density in the voxel data is rewritten, the change amount of the density may be adjusted, depending on the type and state of a material indicated by material data included in the voxel data. For example, the change amount of the density may be adjusted (e.g., the change amount of the density to be rewritten is increased for a more breakable material), depending on a property (e.g., breakability or temperature) of a material indicated by the material data.

The density in the voxel data may also be rewritten by adjusting the change amount of the density, depending on state data included in the voxel data. For example, the state data indicates the amount of damage applied to the terrain object TO by the player character PC. As an example, whether to reduce the density in the voxel data and whether to increase the amount of damage may be determined based on a relationship between the offensive strength of the player character PC and the defensive strength of the terrain object TO. Specifically, based on a relationship between the hardness of the offensive entity (e.g., the hardness of a fist of the player character PC punching the terrain object TO) and the hardness of the defensive (attacked) entity (the hardness of the material of the terrain object TO), the density in the destruction range is rewritten if the hardness of the offensive entity is greater, and neither the density in the destruction range nor the amount of damage is rewritten if the hardness of the defensive (attacked) entity is greater. If the hardness of the offensive entity is substantially equal to the hardness of the defensive (attacked) entity, the amount of damage to voxels in the destruction range is increased, and if the amount of the damage exceeds the acceptable amount of the voxel (the damage endurance value of the material), the densities of the voxels are rewritten. Note that the amount of damage to a voxel exceeds the acceptable amount of the voxel, the density of the voxel may be set to zero, e.g., the voxel may be removed. Thus, the amount of damage to a voxel can serve as voxel data indicating the absence of a terrain.

After the density is rewritten as described above, a mesh is newly formed on a surface (specifically, a surface that is newly exposed to the outside by breaking) of the terrain object TO to update the display. For example, when an event occurs in which the terrain object TO is broken, a mesh is newly formed by recalculating mesh vertices in a range including voxels whose voxel data has been rewritten due to the destruction. As an example, as shown in FIG. 14, mesh vertices are generated. Thus, after voxels are removed, a new mesh is generated according to an algorithm that recalculates mesh vertices between a voxel in which no terrain is present and a voxel in which a terrain is present, based on the densities of voxels, so that the terrain object TO around the buried object OBJ may be removed. In the present example, when the terrain object TO around the buried object OBJ is removed due to generation of such a new mesh, the buried state of the buried object OBJ is determined. Thereafter, texture for use in rendering each face of the mesh is determined based on the voxel data, and the determined texture is mapped to each face, whereby an image of the broken terrain object TO is generated. Note that the range in which mesh recalculation or burial determination is performed may be a chunk including voxels whose voxel data has been rewritten (a process unit including a predetermined number of voxels). For example, if a chunk includes 16×16×16 voxels, and recalculation or burial determination is performed on chunks including voxels whose voxel data has been rewritten, processing can be reduced compared to when a mesh is recalculated or burial determination is performed throughout the game space. The range may be a voxel space in which voxels whose voxel data has been rewritten are located, or the entire terrain object TO, which includes voxels whose voxel data has been rewritten. If the processing load is not so great, a mesh may be recalculated or burial determination may be performed throughout the game space.

Note that in the foregoing, as an example of a game process based on whether or not the buried object OBJ is buried in the terrain object TO after the player character PC performs an action of breaking the terrain object TO, the process of producing a scene that the player character PC unearths the buried object OBJ so that the buried object OBJ drops from the location where the buried object OBJ has been buried to the game field F, or the process of producing a scene that the buried object OBJ itself or an item associated with the buried object OBJ is obtained, is used. However, the game process based on whether or not the buried object OBJ is buried may include a process of producing other scenes. As an example, a process of producing a scene that when the buried object OBJ which has been completely buried in the terrain object TO is partially exposed, the buried object OBJ emits light, or a process of producing a scene that points are obtained according to the type of the buried object OBJ, may be executed. As another example, even if the buried object OBJ is maintained completely buried in the terrain object TO, then when the terrain object TO in the vicinity of the buried object OBJ is broken, a process of producing a scene in which a predetermined sound or vibration is generated, or a process of producing a scene that another character starts moving toward the player character PC, may be executed.

In the foregoing, an example has been described in which the main box MB and the small box SB are set for the buried object OBJ. By using a box having such a basic shape, the load of processing burial determination can be reduced. Alternatively, the main box MB and/or the small box SB may not be set. In the case where the main box MB is not set, contact sites between the buried object OBJ and the terrain object TO may be identified, the cover ratio may be calculated using the volume or surface area of the buried object OBJ, and the centroid of the buried object OBJ may be calculated. In that case, the first determination and the second determination can be similarly executed. In the case where the small box SB is not set, a hole may be formed in the terrain object TO using the buried object OBJ itself, or a hole having a shape different from that of the small box SB may be formed in the terrain object TO, and the buried object OBJ may be buried in the hole.

In the foregoing, as an example of an event in which the terrain object TO is removed, a portion of the terrain object TO is broken and deformed or removed due to the player character PC's breaking action hitting the terrain object TO, e.g., the player character PC punching the terrain object TO. The terrain object TO may also be removed due to other events. For example, in an event, the terrain object TO may be broken by being hit by the entire body or another part such as a leg of the player character PC, or by being hit by the player character PC with an item such as a weapon. In an event, the terrain object TO may also be broken by being hit by another object thrown or kicked by the player character PC, or by being hit by a bullet object fired or launched by the player character PC, or the like. The terrain object TO may also be removed (deformed) due to such events. The terrain object TO may also be removed (deformed) due to environmental changes or the like in the game space such as application of vibrations caused by an earthquake, or crushing power caused by striking wavefront or wind and rain, deterioration caused by exposure to outdoor air, or decomposition, independently of the player character PC's action.

In the foregoing, the terrain object TO is used as an example of an object that is partially removed from the game space. Even in the case where other voxel objects are removed from the game space, a similar burial determination process may, of course, be performed. For example, even when the buried object OBJ is buried in other voxel objects such as buildings and trees provided in the game space, moving bodies such as vehicles moving in the game space, other characters such as opponent characters present in the game space, items provided in the game space, objects such as foods and tools provided in the game space, the process of removing a portion of the buried object OBJ and the burial determination process can be similarly executed.

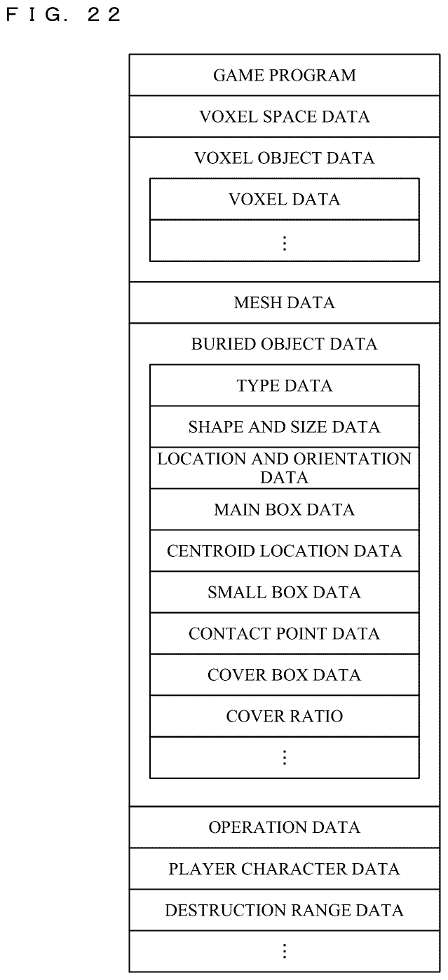

Next, a specific example of an information process of the game system 1 will be described with reference to FIG. 22 to FIG. 24.

FIG. 22 is a diagram showing an example of various kinds of data used in an information process executed in the game system 1. As shown in FIG. 22, the game system 1 stores a game program, voxel space data, voxel object data, mesh data, buried object data, operation data, player character data, destruction range data, and the like. The game program and the voxel space data are previously stored in the game system 1 before a game process is executed. The game program and the voxel space data are, for example, stored in a storage medium attached to the slot 23 of the main body apparatus 2. The voxel object data, mesh data, buried object data, operation data, player character data, and destruction range data are generated during execution of a game process. The voxel object data, mesh data, buried object data, operation data, player character data, and destruction range data are, for example, stored into the DRAM 85 of the main body apparatus 2.

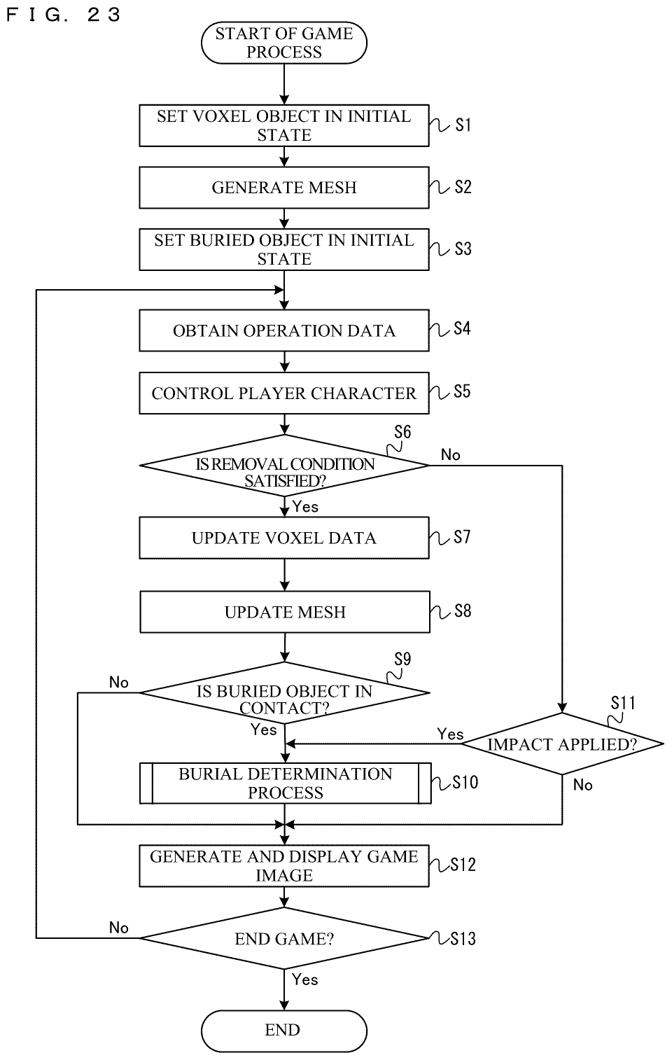

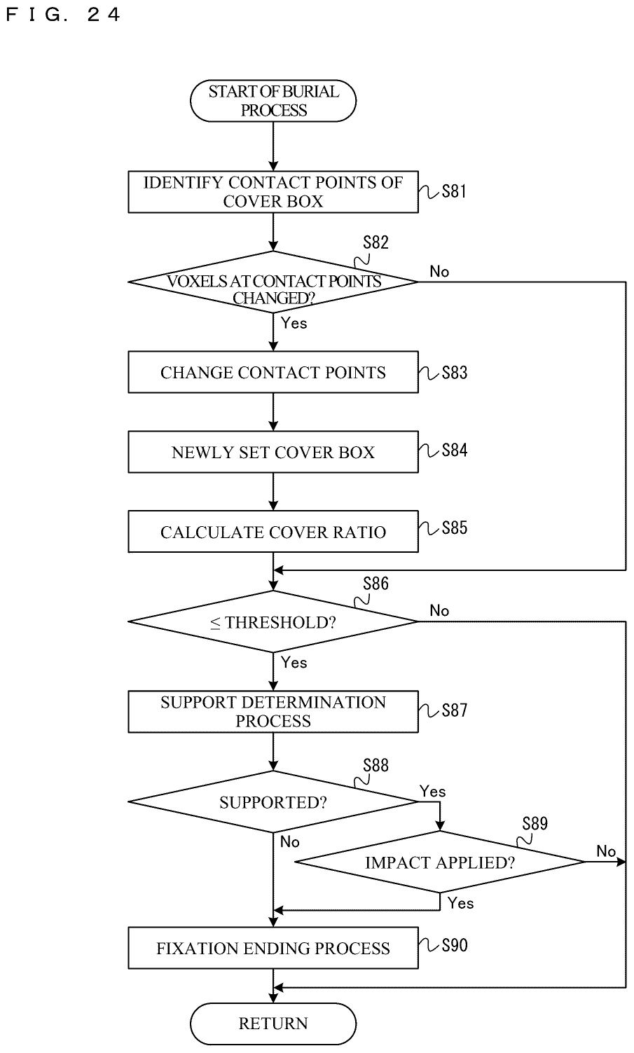

The game program is for executing a game process (specifically, the game process shown in FIGS. 23 and 24) of the present example.

The voxel space data specifies voxels that are set in the game space. Specifically, the voxel space data indicates the length of an edge of each voxel, and the orientation of each edge of the voxel in the game space. In the case in which voxels are set only in part of the game space, the voxel space data includes data indicating the location and size of a space in which voxels are set (e.g., a voxel space) (e.g., data indicating a range of the game space in which voxels are set).

The voxel object data indicates a voxel object that is provided in the game space. Specifically, the voxel object data includes voxel data for each unit region in all or part of the game space.

The mesh data indicates a mesh that is set for a voxel object which is provided in the game space. The mesh data includes, for example, data indicating the vertices of a mesh.

The buried object data indicates a buried object placed in the game space. Specifically, the buried object data includes type data, shape and size data, location and orientation data, main box data, centroid location data, small box data, contact point data, cover box data, and cover ratio data. The type data indicates the type of a buried object. The shape and size data indicates the shape and size of a buried object. The location and orientation data indicates the location and orientation of a buried object placed in the game space. The main box data indicates the shape and size of a main box set for a buried object, and the location and orientation in the game space of the main box. The centroid location data indicates the location in the game space of the centroid of a main box. The small box data indicates the shape and size of a small box set for a buried object, and the location and orientation in the game space of the small box. The contact point data indicates contact sites (contact points) between a main box for a buried object placed in the game space, and a terrain object. The cover box data indicates the shape and size of a cover box for a buried object, and the location and orientation in the game space of the cover box. The cover ratio data indicates a cover ratio calculated for a buried object.

The operation data is obtained, as appropriate, from each of the left controller 3 and/or the right controller 4 and the main body apparatus 2. As described above, the operation data obtained from each of the left controller 3 and/or the right controller 4 and the main body apparatus 2 includes information about an input from each input section (specifically, each button, an analog stick, or a touch panel) (specifically, information about an operation). In the present example, operation data is obtained from each of the left controller 3 and/or the right controller 4 and the main body apparatus 2. The obtained operation data is used to update the operation data as appropriate. Note that the operation data may be updated for each frame that is the cycle of a process (to be described below) executed in the game system 1, or may be updated each time operation data is obtained.

The player character data indicates the place and position of the player character PC placed in the virtual space, the movement and state in the virtual space of the player character PC, and the like.

The destruction range data indicates a destruction range that is set when a terrain object TO is broken by the player character PC.

Note that in addition to the data shown in FIG. 22, the game system 1 stores, for example, data of the above property information and texture information as data that is previously stored in the game system 1 before a game process is executed.

FIG. 23 is a flowchart showing an example of a flow of a game process that is executed in the game system 1. FIG. 24 is a subroutine showing an example of the burial determination process of step S10 in the flowchart of FIG. 23. In the present example, a series of steps shown in FIGS. 23 and 24 are executed by the processor 81 executing the game program. The game processes of FIGS. 23 and 24 are started with any suitable timing. As an example, the game processes of FIGS. 23 and 24 are started according to an instruction to start a game that is provided by a player during execution of the game program.

Note that in the present embodiment, it is assumed that the processor 81 of the main body apparatus 2 executes the game program stored in the game system 1 to execute each step of FIGS. 23 and 24. Note that in another exemplary embodiment, a portion of the steps may be executed by a processor (e.g., a dedicated circuit) other than the processor 81. In the case in which the game system 1 can communicate with another information processing device (e.g., a server), a portion of the steps of FIGS. 23 and 24 may be executed by the information processing device. In other words, the steps of FIGS. 23 and 24 may be executed by a plurality of information processing devices including the main body apparatus 2 working together. The steps of FIGS. 23 and 24, which are merely for illustrative purposes, may be executed in a different order, or another step may be executed in addition to (or instead of) each step, if a similar effect is obtained.

The processor 81 executes the steps of FIGS. 23 and 24 using a memory (e.g., the DRAM 85). Specifically, the processor 81 stores information (in other words, data) obtained in each process step into a memory, and reads and uses the information from the memory when the information is required in a subsequent process step.

In FIG. 23, the processor 81 sets a voxel object in an initial state in the game space (step S1), and proceeds to the next step. Specifically, the processor 81 obtains voxel data indicating the arrangement of a voxel object in an initial state, and stores (in other words, writes) all or a portion of the obtained voxel data as the voxel object data into the DRAM 85. Note that the voxel data indicating the arrangement of a voxel object in an initial state is, for example, stored in a storage medium attached to the slot 23 of the main body apparatus 2. Note that a computer that stores, in a storage medium, terrain volume data holding voxel data indicating the presence of a terrain for each voxel included in a voxel space set in a virtual space and thereby representing a shape of the terrain in the virtual space, and object data representing an object placed at a location where at least a portion of the object is buried in the terrain, corresponds to the processor 81 performing step S1, for example.

Note that voxel data that is written as the voxel object data into the DRAM 85 may be voxel data corresponding to a partial range that is used in generation of a game image, of the voxel data corresponding to the entire range of the game space. For example, the processor 81 may generate an image of an object using voxel data corresponding to only a partial range of the game space (e.g., a range within a predetermined distance from the location of a virtual camera). In that case, the voxel object data may include voxel data within that range. When voxel data corresponding to a partial range of the game space is written, a process similar to step S1 is executed with appropriate timing (e.g., at a timing when the location of the virtual camera is moved by at least a predetermined distance) during execution of steps S4 to S13 to be described below.

Next, the processor 81 generates a mesh for the voxel object (step S2), and proceeds to the next step, in which the processor 81 starts a game, and repeatedly executes steps S3 to S11 in the game. A mesh is generated by the above method. Here, the processor 81 generates a mesh based on the voxel object data stored in the DRAM 85. As a result of step S2, a voxel object such as a terrain object is constructed in the game space.

Next, the processor 81 sets, in the game space, a buried object in an initial state (step S3), and proceeds to the next step. Specifically, the processor 81 places a buried object at an initial location in the game space, and initially sets the buried object data for a buried object, small box, main box, contact point, and cover box placed using the above method described. For example, the processor 81 initially sets the buried object data using the type, shape, size, location, and orientation of a buried object placed at an initial location. The processor 81 also sets a main box for the buried object placed at the initial location, and initially sets the buried object data using the shape, size, location, orientation, and centroid location of the main box. The processor 81 also sets a small box for the buried object placed at the initial location, and initially sets the buried object data using the shape, size, location, and orientation of the small box. The processor 81 also forms a hole in a voxel object, based on the set small box, and updates the voxel object data. Thereafter, the processor 81 identifies contact points of the buried object using the above method, sets a cover box based on the contact points, and initially sets the buried object data using the locations of the contact points, and the shape, size, location, and orientation of the cover box.

Note that the buried object data initially set in step S3 may be related to a buried object present within the range set by the voxel data in step S1. In the case where the buried object data is initially set for a partial range of the game space, a process similar to step S3 is executed with appropriate timing (e.g., at a timing when the location of the virtual camera is moved by at least a predetermined distance) during execution of steps S4 to S13 to be described below.

Next, the processor 81 obtains data corresponding to the user's operation from the left controller 3, the right controller 4, and/or the main body apparatus 2, updates the operation data (step S4), and proceeds to the next step.

Next, the processor 81 controls actions of various objects appearing in the game space (e.g., a player character and an opponent character) (step S5), and proceeds to the next step. For example, the processor 81 controls the player character's action based on the operation data obtained in step S4, and updates the player character data. The processor 81 also controls an opponent character's action based on an algorithm specified in the game program.

Next, the processor 81 determines whether or not a removal condition for removal of at least a portion of the voxel object is satisfied (step S6). For example, if the player character PC has hit the terrain object TO, the processor 81 sets a location where the terrain object TO has been hit and a surrounding range as a destruction range, updates the destruction range data, breaks the terrain object TO (voxel object) present within the destruction range, and removes the broken portion. As an example, in order to represent a state that the destruction range has been broken, the densities indicated by the voxel data of at least a portion of the voxels included in the destruction range are set to zero, whereby the object in the destruction range is removed. Therefore, if a voxel(s) of the voxel object is included in the destruction range hit by the player character, the result of the determination by the processor 81 is step S6 is positive. If the removal condition is satisfied, the processor 81 proceeds to step S7. Otherwise, i.e., if the removal condition is not satisfied, the processor 81 proceeds to step S11.

In step S7, the processor 81 updates the voxel data related to the voxel object that satisfies the removal condition, and proceeds to the next step. For example, in order to remove at least a portion of the voxel object that satisfies the removal condition, the processor 81 changes the densities of voxels in a portion hit by the player character and a surrounding portion, and updates the voxel data corresponding to each voxel. The processor 81 reduces the densities of voxels around the destruction range to be removed (e.g., the hit range) (provided that the reduced density is at least zero), and thereby deforms the voxel object in the voxels around the destruction range. Specifically, the processor 81 updates the voxel object data stored in the DRAM 85 such that the density data is changed for the voxel data of the voxels in the range to be removed and a surrounding portion. Note that the processor 81 may update the density data such that the density indicates a value less than the reference value. For example, the processor 81 may set the densities of voxels in a portion (destruction range) hit by the player character to zero, and may reduce the densities of voxels in a surrounding region by a predetermined value. Note that a computer that updates voxel data such that the voxel data of voxels included in a removal range set based on a location of occurrence of a breaking event indicates the absence of a terrain, corresponds to the processor 81 executing step S7, for example.

Next, the processor 81 updates the mesh for the voxel object whose voxel data has been changed in step S7 (step S8), and proceeds to the next step. Specifically, the processor 81 generates a mesh for the voxel object that satisfies the removal condition, based on the voxel object data updated in step S7. Thus, a mesh for a terrain object can be dynamically changed in a game. Note that the processor 81 updates the mesh data stored in in the DRAM 85 such that the mesh data indicates the newly generated mesh.

Next, the processor 81 determines whether or not the voxel data of voxels in contact with the buried object has been updated in step S7 (step S9). If the voxel data of voxels in contact with the buried object has been updated, the processor 81 proceeds to step S10. Otherwise, i.e., if the voxel data of voxels in contact with the buried object has not been updated, the processor 81 proceeds to step S12.

In step S11, the processor 81 determines whether or not an impact greater than or equal to a predetermined threshold has been applied to the buried object placed in the game space. If an impact greater than or equal to a predetermined threshold has been applied to the buried object, the processor 81 proceeds to step S10. Otherwise, i.e., if an impact greater than or equal to a predetermined threshold has not been applied to the buried object, the processor 81 proceeds to step S12.

In step S10, the processor 81 executes the burial determination process, and proceeds to step S12. The burial determination process of step S10 will be described below with reference to FIG. 24. Note that a computer that executes a first game process, based on whether or not an object is buried in a terrain based on terrain volume data after a destruction event, corresponds to the processor 81 executing step S10, for example.

In FIG. 24, the processor 81 identifies contact points of the buried object for which it has been determined in step S9 that the voxel data of voxels in contact with the buried object has been updated (step S81), and proceeds to the next step. For example, the processor 81 determines whether or not a change has occurred in a voxel at any contact point included in the cover box set for the buried object. Specifically, the processor 81 identifies the contact points of the buried object using the contact point data related to the buried object, and determines whether or not any voxel in the vicinity of the contact points has been removed or deformed.

Next, the processor 81 determines whether or not a change has occurred in any voxel in the vicinity of the contact points (step S82). For example, if the voxels identified in step S81 include any voxel in the vicinity of the contact points that has been removed or deformed, the result of the determination by the processor 81 in step S82 is positive. If a change has occurred in any voxel in the vicinity of the contact points, the processor 81 proceeds to step S83. Otherwise, i.e., if a change has not occurred in any voxel in the vicinity of the contact points, the processor 81 proceeds to step S86.

In step S83, the processor 81 changes contact points, and proceeds to the next step. As an example, the processor 81 removes the contact point of a voxel(s) that it is determined in the identification of step S81 has been removed, from the contact points of the buried object to be processed, and updates the contact point data of the buried object. As another example, the processor 81 updates the contact point data of the buried object by newly identifying the contact points of the buried object to be processed by the above method using, for example, a mesh newly formed based on a voxel(s) that it is determined in the identification of step S81 has been changed.

Next, the processor 81 sets a new cover box for the buried object to be processed (step S84), and proceeds to the next step. For example, the processor 81 sets a new cover box for the buried object to be processed, by the above method using the contact points changed in step S83, and updates the cover box data of the buried object.

Next, the processor 81 calculates the cover ratio (step S85), and proceeds to step S86. For example, the processor 81 calculates the cover ratio by the above method using the main box data and cover box data of the buried object to be processed, and updates the cover ratio data of the buried object.

In step S86, the processor 81 executes the first determination, e.g., determines whether or not the cover ratio is lower than or equal to the threshold, on the buried object for which it is determined in step S9 that the voxel data of voxels in contact with the buried object has been updated, or the buried object to which it is determined in step S11 that an impact has been applied. If the cover ratio of the buried object is lower than or equal to the predetermined threshold, the processor 81 proceeds to step S87. Otherwise, i.e., if the cover ratio of the buried object is higher than the predetermined threshold, the processor 81 ends the subroutine.

In step S87, the processor 81 determines a support determination process, and proceeds to the next step. For example, the processor 81 executes, on the buried object to be processed, the second determination, e.g., the process of determining whether or not the buried object is supported by the terrain object.

Next, the processor 81 determines whether or not the buried object to be processed is supported by the terrain object, based on the support determination process of step S87 (step S88). If the buried object to be processed is supported by the terrain object, the processor 81 proceeds to step S89. Otherwise, i.e., if the buried object to be processed is not supported by the terrain object, the processor 81 proceeds to step S90.

In step S89, the processor 81 determines whether or not an impact greater than or equal to a predetermined magnitude has been applied to the buried object to be processed. For example, if an impact greater than or equal to the predetermined magnitude has been applied to the buried object to be processed due to the player character PC's action or a scene other than that action, the result of the determination by the processor 81 in step S89 is positive. Note that the predetermined magnitude may be a predetermined invariable value of an impact force, or a value varying depending on the magnitude of the cover ratio of the buried object to be processed (e.g., the value decreases with a decrease in the cover ratio). If an impact greater than or equal to the predetermined magnitude has been applied to the buried object to be processed, the processor 81 proceeds to step S90. Otherwise, i.e., if an impact greater than or equal to the predetermined magnitude has not been applied to the buried object to be processed, the processor 81 end the subroutine.

In step S90, the processor 81 executes a process of ending the fixation of the buried object, and ends the subroutine. For example, the processor 81 ends the state that the buried object to be processed is fixed to the terrain object, causes the buried object to drop from the location where the buried object is located at the terrain object toward the game field F in accordance with a physical law set in the game space, and updates the buried object data. Note that in the case where the buried object whose fixation has been ended or an item associated with the buried object is automatically obtained by a player character, the buried object may be removed from the game space by execution of a process related to the obtaining process, without providing a scene that the buried object drops in step S90.

Referring back to FIG. 23, in step S12, the processor 81 generates and displays a game image of the game space on a display device, and proceeds to the next step. Specifically, the processor 81 generates a game image of the game space including the voxel object, the buried object, and other objects (e.g., a player character and an opponent character). Note that an image of a voxel object is generated by the above method using the voxel object data and the mesh data stored in the DRAM 85. An image of a buried object is generated based on the buried object data stored in the DRAM 85. An image of a player character is generated using the player character data stored in the DRAM 85. Thereafter, the processor 81 displays the generated game image on a display device. Note that in a game, step S12 is repeatedly executed at a rate of once per predetermined time (e.g., one frame time). A computer that generates an image of a virtual space by rendering at least a polygon mesh representing a surface of a terrain, based on terrain volume data, corresponds to the processor 81 executing steps S8 and S12, for example.

Next, the processor 81 determines whether or not to end the game (step S13). In step S13, the game process is ended, for example, if a condition for ending the game process is satisfied, the user has performed an operation of ending the game process, or the like. If the processor 81 does not determine to end the game process, the processor 81 returns to step S4, and repeats the process. Otherwise, i.e., if the processor 81 determines to end the game process, the processor 81 ends the flowchart. Following this, steps S4 to S13 are repeated executed until the processor 81 determines to end the game process in step S13.

Thus, in the present example, a game can be performed using a buried object that is buried in a terrain object generated from voxels, by deforming the terrain object with a high degree of freedom according to the user's operation.

As can be seen from the above flowchart, when an event in which the player character PC breaks the terrain object TO occurs, the process of removing broken voxels in step S7 and the process of dealing with a buried object buried due to destruction in step S10 are executed. The execution of these two processes can quickly determine the state of a buried object due to destruction.

The game system 1 may be any suitable apparatus, including a handheld game apparatus, or any suitable handheld electronic apparatus (a personal digital assistant (PDA), mobile telephone, personal computer, camera, tablet computer, etc.), etc. In that case, an input apparatus for performing an operation of causing a player object PC to perform an action may be, instead of the left controller 3 or the right controller 4, another controller, mouse, touchpad, touch panel, trackball, keyboard, directional pad, slidepad, etc.

In the foregoing, the information processes are performed in the game system 1. Alternatively, at least a portion of the process steps may be performed in another apparatus. For example, when the game system 1 can also communicate with another apparatus (e.g., another server, another information processing apparatus, another image display apparatus, another game apparatus, another mobile terminal, etc.), the process steps may be executed in cooperation with the second apparatus. By thus causing another apparatus to perform a portion of the process steps, a process similar to the above process can be performed. The above information process may be executed by a single processor or a plurality of cooperating processors included in an information processing system including at least one information processing apparatus. In the above non-limiting example, the information processes can be performed by the processor 81 of the game system 1 executing predetermined programs. Alternatively, all or a portion of the above processes may be performed by a dedicated circuit included in the game system 1.

Here, according to the above non-limiting variation, the present example can be implanted in a so-called cloud computing system form or distributed wide-area and local-area network system forms. For example, in a distributed local-area network system, the above process can be executed by cooperation between a stationary information processing apparatus (a stationary game apparatus) and a mobile information processing apparatus (handheld game apparatus). It should be noted that, in these system forms, each of the above steps may be performed by substantially any of the apparatuses, and the present example may be implemented by assigning the steps to the apparatuses in substantially any manner.

The order of steps, setting values, conditions for determination, etc., used in the above information process are merely illustrative, and of course, other order of steps, setting values, conditions for determination, etc., may be used to implement the present example.

The above programs may be supplied to the game system 1 not only through an external storage medium, such as an external memory, but also through a wired or wireless communication line. The program may be previously stored in a non-volatile storage device in the game system 1. Examples of an information storage medium storing the program include non-volatile memories, and in addition, CD-ROMs, DVDs, optical disc-like storage media similar thereto, and flexible disks, hard disks, magneto-optical disks, and magnetic tapes. The information storage medium storing the program may be a volatile memory storing the program. Such a storage medium may be said as a storage medium that can be read by a computer, etc. (computer-readable storage medium, etc.). For example, the above various functions can be provided by causing a computer, etc., to read and execute programs from these storage media.

While several non-limiting example systems, methods, devices, and apparatuses have been described above in detail, the foregoing description is in all aspects illustrative and not restrictive. It should be understood that numerous other modifications and variations can be devised without departing from the spirit and scope of the appended claims. It is, therefore, intended that the scope of the present technology is limited only by the appended claims and equivalents thereof. It should be understood that those skilled in the art could carry out the literal and equivalent scope of the appended claims based on the description of the present example and common technical knowledge. It should be understood throughout the present specification that expression of a singular form includes the concept of its plurality unless otherwise mentioned. Specifically, articles or adjectives for a singular form (e.g., “a”, “an”, “the”, etc., in English) include the concept of their plurality unless otherwise mentioned. It should also be understood that the terms as used herein have definitions typically used in the art unless otherwise mentioned. Thus, unless otherwise defined, all scientific and technical terms have the same meanings as those generally used by those skilled in the art to which the present example pertain. If there is any inconsistency or conflict, the present specification (including the definitions) shall prevail.

As described above, the present example can be used as a game program, game system, game apparatus, and game processing method that are capable of deforming an object generated from voxels with a high degree of freedom according to a user's operation in a game.

What is claimed is:

1. A non-transitory computer-readable storage medium having stored therein a game program that, when executed, causes one or more processors of an information processing apparatus to execute information processing comprising:
storing, in a storage medium, terrain volume data holding voxel data indicating the presence of a terrain for each voxel included in a voxel space set in a virtual space and thereby representing a shape of the terrain in the virtual space, and object data representing an object placed at a location where at least a portion of the object is buried in the terrain;
when a destruction event in which the terrain is broken based on a user's operation input occurs,
updating the voxel data such that the voxel data indicates the absence of the terrain with respect to a voxel included in a removal range set based on a location of the occurrence of the destruction event, and
executing a first game process, based on whether or not the object is buried in the terrain based on the terrain volume data after the destruction event; and
generating an image of the virtual space by rendering at least a polygon mesh representing a surface of the terrain, based on the terrain volume data.

2. The non-transitory computer-readable storage medium according to claim 1, wherein
the information processing further comprises:
executing the first game process, additionally based on whether or not the object is supported by the terrain based on the terrain volume data after the destruction event.

3. The non-transitory computer-readable storage medium according to claim 1, wherein
the information processing further comprises:
identifying a contact site between a first determination shape that is a shape of the object or a basic shape including the object, and the terrain; and
executing first determination to determine that the object is buried in the terrain when a ratio of a volume or surface area of a second determination shape that is a basic shape including the contact site to that of the first determination shape is higher than a reference.

4. The non-transitory computer-readable storage medium according to claim 3, wherein
the information processing further comprises:
executing second determination to determine whether or not the object is supported by the terrain, based on a positional relationship of the centroid of the first determination shape and the second determination shape; and
executing the first game process, based on the first determination and the second determination.

5. The non-transitory computer-readable storage medium according to claim 4, wherein
in the second determination, it is determined that the object is supported by the terrain, when the second determination shape or a third determination shape including the second determination shape includes the centroid in terms of components other than a height direction, and at least a portion of the second or third determination shape is located lower than the centroid in terms of the height direction.

6. The non-transitory computer-readable storage medium according to claim 4, wherein
the information processing further comprises:
executing the first game process when it is determined in the first determination that the object is not buried in the terrain, and it is determined in the second determination that the object is not supported by the terrain, or when an event occurs.

7. The non-transitory computer-readable storage medium according to claim 3, wherein
the first determination shape is a bounding box for the object, and
the second determination shape is a bounding box for the contact site.

8. The non-transitory computer-readable storage medium according to claim 7, wherein
the bounding box is a directed bounding box.

9. The non-transitory computer-readable storage medium according to claim 1, wherein
the information processing further comprises:
causing a player character to perform an action of breaking the terrain, based on the user's operation input, and
in the destruction event, the terrain is hit by the player character's breaking action.

10. The non-transitory computer-readable storage medium according to claim 1, wherein
the first game process is to obtain an item associated with the object.

11. The non-transitory computer-readable storage medium according to claim 1, wherein
the first game process is to cause the object to drop in the virtual space.

12. The non-transitory computer-readable storage medium according to claim 1, wherein
in the absence of the destruction event, the object is placed at a location where a hole having a basic shape smaller than that of the object is formed in a surface or inside of the terrain.

13. The non-transitory computer-readable storage medium according to claim 1, wherein
the information processing further comprises:
generating the polygon mesh according to an algorithm that determines a location of a vertex of a polygon between a voxel in which the terrain is absent and a voxel in which the terrain is present, based on the voxel data; and
recalculating vertices of the polygon mesh in a range including at least a voxel whose voxel data has been updated, based on the occurrence of the destruction event.

14. A game system comprising:
a storage medium storing terrain volume data holding voxel data indicating the presence of a terrain for each voxel included in a voxel space set in a virtual space and thereby representing a shape of the terrain in the virtual space, and object data representing an object placed at a location where at least a portion of the object is buried in the terrain; and
one or more processors that are configured to execute information processing comprising:
when a destruction event in which the terrain is broken based on a user's operation input occurs,
updating the voxel data such that the voxel data indicates the absence of the terrain with respect to a voxel included in a removal range set based on a location of the occurrence of the destruction event, and
executing a first game process, based on whether or not the object is buried in the terrain based on the terrain volume data after the destruction event; and
generating an image of the virtual space by rendering at least a polygon mesh representing a surface of the terrain, based on the terrain volume data.

15. The game system according to claim 14, wherein
the information processing further comprises:
executing the first game process, additionally based on whether or not the object is supported by the terrain based on the terrain volume data after the destruction event.

16. The game system according to claim 14, wherein
the information processing further comprises:
identifying a contact site between a first determination shape that is a shape of the object or a basic shape including the object, and the terrain; and
executing first determination to determine that the object is buried in the terrain when a ratio of a volume or surface area of a second determination shape that is a basic shape including the contact site to that of the first determination shape is higher than a reference.

17. The game system according to claim 16, wherein
the information processing further comprises:
executing second determination to determine whether or not the object is supported by the terrain, based on a positional relationship of the centroid of the first determination shape and the second determination shape; and
executing the first game process based on the first determination and the second determination.

18. The game system according to claim 17, wherein
in the second determination, it is determined that the object is supported by the terrain, when the second determination shape or a third determination shape including the second determination shape includes the centroid in terms of components other than a height direction, and at least a portion of the second or third determination shape is located lower than the centroid in terms of the height direction.

19. The game system according to claim 17, wherein
the information processing further comprises:
executing the first game process when it is determined in the first determination that the object is not buried in the terrain, and it is determined in the second determination that the object is not supported by the terrain, or when an event occurs.

20. The game system according to claim 16, wherein
the first determination shape is a bounding box for the object, and
the second determination shape is a bounding box for the contact site.

21. The game system according to claim 20, wherein
the bounding box is a directed bounding box.

22. The game system according to claim 14, wherein
the information processing further comprises:
causing a player character to perform an action of breaking the terrain, based on the user's operation input, and
in the destruction event, the terrain is hit by the player character's breaking action.

23. The game system according to claim 14, wherein
the first game process is to obtain an item associated with the object.

24. The game system according to claim 14, wherein
the first game process is to cause the object to drop in the virtual space.

25. The game system according to claim 14, wherein
in the absence of the destruction event, the object is placed at a location where a hole having a basic shape smaller than that of the object is formed in a surface or inside of the terrain.

26. The game system according to claim 14, wherein
the information processing further comprises:
generating the polygon mesh according to an algorithm that determines a location of a vertex of a polygon between a voxel in which the terrain is absent and a voxel in which the terrain is present, based on the voxel data; and
recalculating vertices of the polygon mesh in a range including at least a voxel whose voxel data has been updated, based on the occurrence of the destruction event.

27. A game apparatus comprising:
a storage medium storing terrain volume data holding voxel data indicating the presence of a terrain for each voxel included in a voxel space set in a virtual space and thereby representing a shape of the terrain in the virtual space, and object data representing an object placed at a location where at least a portion of the object is buried in the terrain; and
one or more processors that are configured to execute information processing comprising:
identifying a contact site between a first determination shape that is a shape of the object or a basic shape including the object, and the terrain;
when a destruction event in which the terrain is broken based on a user's operation input occurs,
updating the voxel data such that the voxel data indicates the absence of the terrain with respect to a voxel included in a removal range set based on a location of the occurrence of the destruction event, and
executing first determination to determine that the object is buried in the terrain based on the terrain volume data after the destruction event when a ratio of a volume or surface area of a second determination shape that is a basic shape including the contact site to that of the first determination shape is higher than a reference, and executing a first game process, based on the first determination; and
generating an image of the virtual space by rendering at least a polygon mesh representing a surface of the terrain, based on the terrain volume data.

28. The game apparatus according to claim 27, wherein
the information processing further comprises:
executing second determination to determine whether or not the object is supported by the terrain, based on a positional relationship of the centroid of the first determination shape and the second determination shape; and
executing the first game process based on the first determination and the second determination.

29. The game apparatus according to claim 28, wherein
in the second determination, it is determined that the object is supported by the terrain, when the second determination shape or a third determination shape including the second determination shape includes the centroid in terms of components other than a height direction, and at least a portion of the second or third determination shape is located lower than the centroid in terms of the height direction.

30. A game processing method performed on an information processing apparatus, the game processing method comprising:
storing, in a storage medium, terrain volume data holding voxel data indicating the presence of a terrain for each voxel included in a voxel space set in a virtual space and thereby representing a shape of the terrain in the virtual space, and object data representing an object placed at a location where at least a portion of the object is buried in the terrain;
identifying a contact site between a first determination shape that is a shape of the object or a basic shape including the object, and the terrain;
when a destruction event in which the terrain is broken based on a user's operation input occurs,
updating the voxel data such that the voxel data indicates the absence of the terrain with respect to a voxel included in a removal range set based on a location of the occurrence of the destruction event, and
executing first determination to determine that the object is buried in the terrain based on the terrain volume data after the destruction event when a ratio of a volume or surface area of a second determination shape that is a basic shape including the contact site to that of the first determination shape is higher than a reference, and execute a first game process, based on the first determination; and
generating an image of the virtual space by rendering at least a polygon mesh representing a surface of the terrain, based on the terrain volume data.

31. The game processing method according to claim 30, wherein
the method causes the information processing apparatus to further execute:
executing second determination to determine whether or not the object is supported by the terrain, based on a positional relationship of the centroid of the first determination shape and the second determination shape; and
executing the first game process based on the first determination and the second determination.

32. The game processing method according to claim 31, wherein
in the second determination, it is determined that the object is supported by the terrain, when the second determination shape or a third determination shape including the second determination shape includes the centroid in terms of components other than a height direction, and at least a portion of the second or third determination shape is located lower than the centroid in terms of the height direction.
